(19) United States
(12) Patent Application Publication
(10) Pub. No.: US 2004/0168266 A1
(43) Pub. Date: Sep. 2, 2004

(54) Methods and products useful in recovering and recycling tannins

(76) Inventor: G Wayne McGraw, Pineville, LA (US)

Correspondence Address: MCNEES, WALLACE & NURICK, 100 PINE STREET, P.O. BOX 1166, HARRISBURG, PA, 17108-1166, US

(21) Appl. No.: 10/471,879

(22) PCT Filed: Mar. 15, 2002
(86) PCT No.: PCT/US02/08180

Related U.S. Application Data
(60) Provisional application No. 60/275,983, filed on Mar. 15, 2001.

(51) Int. Cl. C09B 67/34

(52) U.S. Cl. 8/440

(57) ABSTRACT

The present invention relates to a novel method of recovering and recycling active tannins from spent vegetable tanning liquors. Using a low molecular weight alcohol as the extraction agent produces an alcohol fraction or precipitate containing extracted active tannins, and leaves virtually all non-tannins in the aqueous phase of the spent tanning liquor. The methods and resulting chemical mixtures of the present invention have a variety of uses and applications. The method can be applied to freshly produced or aged spent vegetable tanning liquors. The methods are further applicable to dried forms of spent tanning liquors through aqueous reconstitution of dried ReTan, followed by alcohol extraction. The recovered chemical mixture contains recovered tannins which can be recycled through combination with fresh tanning liquors to form an improved tanning liquor.

### TECHNICAL FIELD

The present invention is directed to the field of chemicals and methods used in tanning of animal hides to produce leather. In particular, the present invention is directed to tanning methods which utilize vegetable extracts known as plant polyphenols as the active tanning agent, and to the recovery and recycling of tannins from spent tanning liquors and associated solids produced in the leather tanning process. The invention is further directed to the production of leathers using the novel chemical mixture recovered by treating spent tanning liquors and associated solids with low molecular weight alcohols.

### BACKGROUND ART

Tanning of animal hides to form leather is an art that dates back thousands of years. As the art has evolved, some methods have been shown to be superior to others. One method may produce a stronger, tougher leather, while another method may be more suitable for producing fine, soft, or colored leather. Modern tanning methods can be classified into essentially two classes: 1) methods using chromium salts (“chrome tanning”); and, 2) and methods using vegetable tannins known as plant polyphenols (“vegetable tanning”).

Chrome tanning is the primary method used by United States tanneries, and is believed to account for over 75% of all cattle leather produced. Chrome tanning produces a tougher leather, and has the disadvantage of producing waste streams containing chromium.

Vegetable tanning is the preferred method for production of premium leathers, including colored leathers and fine, soft leathers. Plant polyphenols extracted from tree bark or wood serve as the active tannins in vegetable tanning liquors. While specific tanning liquor ingredients are dependent on the type of leather produced, cattle leather tanning commonly uses tannin extracts from Quebracho and Wattle trees (from South Africa and South America). Extracts from Chestnut, Tara, and other trees are also known in the art for use to tan hides into leather. Additionally, synthetic tannins (such as Syntan® and DLE-P from BASF Corp.) may be mixed with one or more natural tannins. Tannin extracts are commonly provided in powder form, and are mixed with water to make a tanning liquor. When more than one extract is used, the tanning liquor is referred to as a “blend”. Commonly used tanning liquors are a blend, and commonly have a percent tannin concentration ranging from approximately 8% to 12%. However, the tannin percentage can be adjusted by tanners to correlate with the type of hide, process, and desired leather product.

Vegetable tanning is most prevalent in Mexico, Italy, Spain, and other countries. The premium vegetable tannery located in the United States is the E. H. Hall/Westfield Tannery (hereinafter “Westfield Tannery” or “Westfield”). The Westfield Tannery is located in the town of Westfield, Tioga County, Pa., and is believed to be the largest remaining American vegetable leather tannery. The Westfield Tannery utilizes a vegetable tanning method called the LIRITAN process, which is the most common process worldwide for vegetable tanning. The LIRITAN process is well known in the art, and is described in: 1) S. G. Shuttleworth, “The Liritan ‘no effluent’ rapid pit tannage sole leather process”, J. Soc. Leather Trades' Chem., 47:143 (1963); and, 2) N. P. Slabbert, “Leather Manufacture with Wattle Tannins”, in Plant Polyphenols: Synthesis, Properties, Significance, R. W. Hemingway and P. E. Laks, eds., Plenum Press, 1992. Prior to the LIRITAN process, tanneries used the “press” system, which could take several months to achieve complete penetration. The LIRITAN process shortens the tanning process to about 12 days.

The LIRMTAN process basically involves using Calgon (sodium hexametaphosphate) to improve the penetration of tannin. Hides are pre-treated in a solution of sodium hexametaphosphate for approximately 20 hours. The treated hides are then placed in tanning liquor containing plant polyphenols as active tannins, and the phosphate salts in the hides are displaced by the tannins. This displacement results in high phosphate concentrations in the spent tanning liquor.

A problem with the LIRITAN process, and all known vegetable tanning processes, is that the tanning effect of the tanning liquor is diminished after processing of several batches of animal hides. When properly prepared hides are soaked for extended periods of time in vats of tanning liquor, the hides lose all putrefiable material, and adsorb tannins. This process produces the desired stable tanned leather. After processing of several batches of animal hides in the tanning liquor, putrefiable materials, phosphates and other salts, and other tanning by-products (hereinafter “solids”) have accumulated, causing an increase in the time required for complete tannin penetration of newly added hides. This build-up of solids eventually reaches the point where the process is rendered uneconomical causing the liquor to be discharged in favor of more active materials. For example, on average, Westfield generates 14,000 gallons/day (53,000 liters/day) of spent liquor having approximately 4% solids. Active tannins remain trapped in the spent liquor, as do phosphate salts and other assorted solids.

The problem of accumulated spent tanning liquors creates serious economic and environmental concerns. Therefore, most tanneries concentrate the spent tanning liquors by drying or evaporating off excess water and other liquid. At Westfield, spent liquor is often processed in a triple effect evaporator to a more concentrated liquor (between 20 and 40% solids). Westfield further processes this concentrated tanning liquor in a box dryer to produce a powdered material (over 98% solids). Westfield markets the residual solids from a 300,000 gallon per day Sequencing Batch Reactor (SBR) wastewater treatment facility as a Pennsylvania Department of Agriculture registered soil fertilizer/pH adjustment product which can be used by farmers. However, environmental regulations and associated costs effectively prevent use of much of the dried ReTan as fertilizer. Thus, millions of pounds of dried ReTan containing trapped plant polyphenols accumulate at vegetable tanneries, with no effective solution to recover and recycle the trapped plant polyphenols.

Therefore, the need exists for a method of recovering and recycling of plant polyphenols (active tannins) and water from spent vegetable tanning liquor (ReTan). Additionally, there exists a continuing and unmet need for recycling of dried ReTan to recover active tannins. There further exists a need for a method which utilizes recycled active tannins in the vegetable tanning process. Lastly, there exists a continuing need for an improved active vegetable tannin which can be combined with virgin tannins to produce a tanning liquor which results in reduced leather tanning times.

### DISCLOSURE OF INVENTION

The present invention provides an economically efficient and environmentally friendly solution to the problem of accumulated liquid and solid wastes produced by the vegetable leather tanning industry. The present invention relates to methods and processes for recovering active tannins from spent vegetable tanning liquors using alcohol. The result of the method and process is a novel chemical mixture which contains recovered active tannins, among other things.

The present invention further relates to methods and processes for utilization of the novel chemical mixture recovered from spent vegetable tanning liquors. In one embodiment, wherein the chemical mixture containing active tannins is recovered from spent tanning liquors by isopropyl alcohol fractionation and mixed with virgin plant polyphenols, an improved tanning liquor is produced. The improved tanning liquor exhibits excellent performance in the form of increased adsorption rates leading to reduced tanning times. Use of the improved tanning liquor also produces leather products having novel characteristics.

The present invention further relates to a soil fertilizer and pH adjustment product which is produced by the alcohol fractionation methods and processes of the present. The soil fertilizer and pH adjustment product is novel as compared to known ReTan in that plant polyphenol content is significantly reduced.

### BRIEF DESCRIPTION OF DRAWINGS

FIG. 1 illustrates NMR Spectra of 200:200 Ratio SuperReTan pursuant to the trials described in Example 5 hereof FIG. 2 illustrates a Representation of the Structures of Sulfonated Wattle and Quebracho Tannins as described in Example 5 hereof.

FIG. 3 illustrates Computed 13C Chemical Shifts for a Generalized Representative Structure of the Yard Blend and SuperReTan as described in Example 5 hereof.

FIG. 4 illustrates a Tannin Recovery Graph which illustrates the Effect of Fractionation as described in Example 7 hereof.

FIG. 5 is a Tannin Recovery Graph which illustrates Average Tannin Recovery for the Multiple Replication Trial as described in Example 7 hereof FIG. 6 is a Tannin Recovery Graph which illustrates Various Aged Powdered ReTan Recovery as described in Example 7 hereof.

FIG. 7 is a Tannin Recovery Graph which illustrates Tannin Recovery in the Multiple Replication Trial as described in Example 7 hereof FIG. 8A illustrates a Process Flow Diagram (Part I) as described in Example 11 hereof.

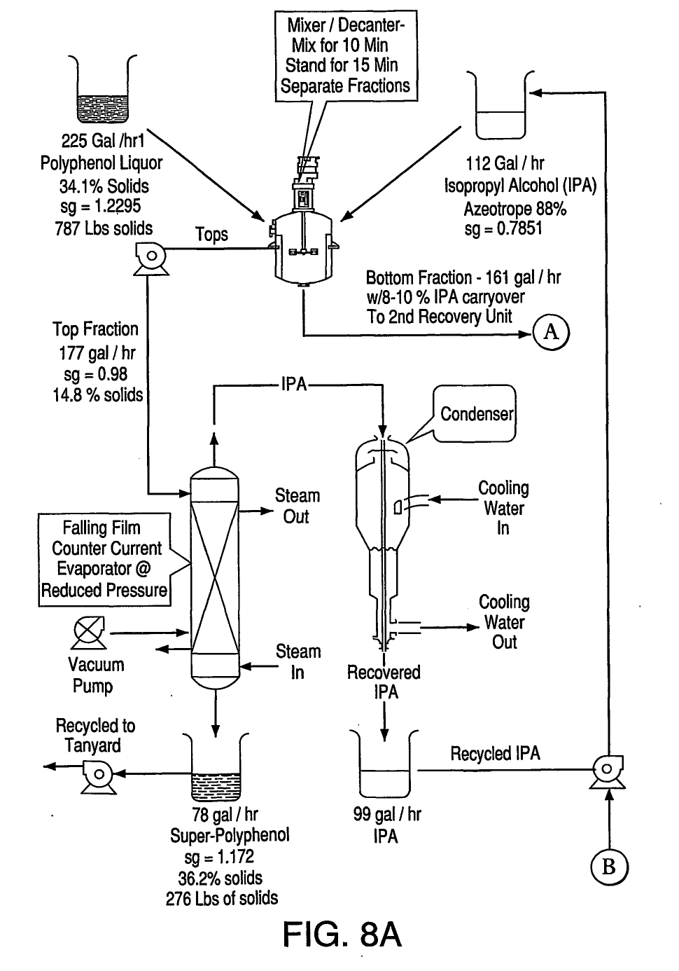

FIG. 8B illustrates a Process Flow Diagram (Part II) as described in Example 11 hereof.

### MODES FOR CARRYING OUT THE INVENTION

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

The present invention relates to a novel method of recovering and recycling active tannins from spent vegetable tanning liquors using alcohol. It has been surprisingly found that one particular embodiment of the present invention using isopropyl alcohol as the extraction agent produces a clean, separate alcohol layer containing extracted active tannins, and leaves virtually all non-tannins in the aqueous phase of the spent tanning liquor. The residue produced by this method comprises a novel mixture, as further described hereinafter.

The methods of the present invention have a variety of uses and applications. The methods can be applied to spent vegetable tanning liquors, whether freshly produced or aged. The methods are further applicable to dried forms of spent tanning liquors through aqueous reconstitution of dried ReTan, followed by alcohol extraction.

The methods of the present invention produce a novel residue having active tannins. The recovered active residue comprises a unique chemical mixture which, when mixed with tanning liquors containing virgin plant polyphenols, exhibit 5 improved tanning performance, including but not limited to faster absorption into hides, and decreased tanning times.

The following discussion describes the present invention in the context of an alcohol fractionation method for recovering and recycling active tannins from spent vegetable tanning liquors. It should be understood that the embodiments described hereinafter merely set forth preferred embodiments of the present invention, and are not intended to be limiting in any way. The steps and elements described in each preferred embodiment may be modified or altered using methods known to those skilled in the art to produce additional embodiments which are within the scope of the present invention.

In one preferred embodiment of the invention, the method of recovering active tannins from spent tanning liquors comprises: providing spent vegetable tanning liquors having solids in the range of 15-40% by weight; adding an alcohol to said spent tanning liquors to form a mixture; agitating said mixture; allowing said mixture to settle to form an alcohol fraction and an aqueous fraction; separating said alcohol fraction from said aqueous fraction; and, removing said alcohol from said alcohol fraction to form a residue containing plant polyphenols (SuperReTan). In a more preferred embodiment, the spent tanning liquors provided preferably have solids in the range of 25% to 35%, and the alcohol is a low molecular weight alcohol. In a most preferred embodiment, the alcohol is selected from the group consisting of isopropyl alcohol (also known as 2-propanol), n-propyl alcohol (also known as 1-propanol), n-butyl alcohol (also known as 1-butanol), sec-butyl alcohol (also known as 2-butanol), isobutyl alcohol (also known as 2-methyl-1-propanol), and tert-butyl alcohol (also known as 2-methyl-2-propanol).

In another embodiment, the method of recovering active tannins from spent tanning liquors comprises: providing spent vegetable tanning liquors having solids in the range of 15-40% by weight; adding an alcohol to said spent tanning liquors to form a mixture; agitating said mixture; allowing said mixture to settle to form a precipitate and an alcohol aqueous fraction; separating said precipitate from said aqueous alcohol fraction; and removing said alcohol from said aqueous alcohol fraction to form a residue containing plant polyphenols (SuperReTan). This method may additionally contain the step of drying said precipitate to produce a soil fertilizer and pH adjustment product. In a more preferred embodiment, the spent tanning liquors provided preferably have solids in the range of 25% to 35%, and the alcohol is a low molecular weight alcohol. In the most prefered embodiment, the alcohol is selected from the group consisting of methyl alcohol and ethyl alcohol. The residue produced by this method comprises a novel mixture, as further described hereinafter.

The alcohol fractionation methods of the present invention also produce a novel aqueous fraction having a reduced level of active tannins. The aqueous fraction can be further processed by drying to produce a novel soil fertilizer and pH adjustment product. The resulting soil fertilizer and pH adjustment product is novel in that it contains a greatly reduced active tannin content as compared to known dried ReTan.

In another embodiment, an improved method of tanning leather is provided which utilizes active tannins recovered by alcohol fractionation of spent vegetable tanning liquors. In a preferred embodiment, the improved method comprises: providing spent vegetable tanning liquors having solids in the range of 1540% by weight; adding an alcohol to said spent tanning liquors to form a mixture; agitating said mixture; allowing said mixture to settle to form an alcohol fraction and an aqueous fraction; separating said alcohol fraction from said aqueous fraction; and, removing said alcohol from said alcohol fraction to form a residue containing plant polyphenols (SuperReTan); adding said residue containing plant polyphenols to virgin tanning liquors to form an improved tanning liquor; and, exposing prepared animal hides to said improved tanning liquor for a time sufficient to tan said hides. In a more preferred embodiment, the spent tanning liquors provided have solids in the range of 25% to 35%, and the alcohol is selected from the group consisting of: isopropyl alcohol, methyl alcohol, ethyl alcohol, and n-propyl alcohol. Preferably, the recovered tannins are added to virgin plant polyphenols in the ratio of 1 part recovered tannins to 4 parts virgin polyphenols to form a novel improved vegetable tanning liquor.

The following examples set forth additional embodiments of the methods, chemical compositions, and products of the present invention, and are not intended to be limiting in any way.

### Example 1

Tannin Recovery From Reconstituted Dried ReTan Using Ethyl Alcohol And Isopropyl Alcohol

Suspension of dried ReTan powder (one part) in ethyl alcohol (5 parts) and filtration gave approximately 32 percent yield of an ethyl alcohol-soluble product that was also 98.10% soluble in water and that had an active tannin content of 63.96% as determined by the hide powder method as shown in Table 1.

The ethyl alcohol-insoluble fraction of the ReTan was an orange-brown granular material which was easily filtered from the soluble portion. Alternatively, the insoluble fraction could be separated by known centrifuge methods. Because commercial virgin tannin extracts contain between 60% and 70% active tannin in the form of plant polyphenols, the inventor attempted fractionation and extraction of the active tannins from the ReTan by addition of alcohols and resulting phase separation. The inventor also felt that the insoluble fraction containing high levels of phosphate and much lower tannin levels, might be a valuable source of phosphate, possibly for use as a fertilizer and pH adjustment product. Furthermore, because it is economically preferable to reuse as much water as possible in the tanning process, and to avoid the costs of drying concentrated spent tanning liquor, the inventor experimented with using ReTan in a post triple effect evaporator and pre-box dryer form (20%-40% solids).

Toward this end, ethyl alcohol was added to a 30% solids ReTan concentrate at volume ratios of either 3:1 or 4:1 to produce a precipitate. The ethyl alcohol soluble fractions were recovered in yields of 44.2 and 43.0 percent and the active tannin content of those products exceeded 50% (Table 1). The precipitate was readily separated by filtration or centrifigation. In an effort to reduce the amount of alcohol used in this separation, we examined the use of isopropyl alcohol (IPA) rather than ethyl alcohol because the boiling point is not markedly higher and a usable azeotrope containing approximately 88% isopropyl alcohol could be recycled. Addition of isopropyl alcohol to the 30% solids concentrate (1:1 v/v) resulted in a phase separation with the lower aqueous-phase containing the majority of the phosphate salt and an upper alcohol-soluble fraction containing tannin. On a dry basis, the IPA-soluble fraction was obtained in 55.5% yield of the ReTan; that material was 98.30% water soluble with an active tannin content of 62.05% (Table 1). This combination of a high yield and a high tannin content were the factors stimulating this research and development project and makes the economics of a break-even recovery system economically possible.

TABLE 1
Initial Tannin Analyses

| | Sample | | | | |
|---|---|---|---|---|---|
| | | ReTan liquor at approximately30 Percent solids | | | Ethyl Alcohol |
| | | | | Isopropyl | 5:1 (vol:mass) |
| | Original | Ethyl Alcohol | Ethyl Alcohol | Alcohol | solvent to |
| | ReTan | 3:1 (vol:vol) | 4:1 (vol:vol) | 1:1 (vol:vol) | powdered |
| Parameter | (powder) | solvent:ReTan | solvent:ReTan | solvent:ReTan | ReTan |
| As Received | | | | | |
| Basis (Percent) | | | | | |
| Moisture | 5.71 | 6.46 | 6.92 | 7.09 | 14.35 |
| Total Solids | 94.29 | 93.54 | 93.08 | 92.91 | 85.65 |
| Soluble Solid | 93.92 | 93.10 | 92.25 | 91.33 | 84.02 |
| Insolubles | 0.37 | 0.44 | 0.83 | 1.58 | 1.63 |
| Non-Tans | 62.80 | 44.37 | 42.38 | 33.68 | 29.24 |
| Tannins | 31.12 | 48.73 | 49.87 | 57.65 | 54.78 |
| Purity | 33.13 | 52.34 | 54.06 | 63.12 | 65.02 |
| pH | 3.69 | 3.02 | 2.98 | 3.14 | 2.53 |
| Dry Basis | | | | | |
| (Percent) | | | | | |
| Total Solids | 100.00 | 100.00 | 100.00 | 100.00 | 100.00 |
| Soluble Solid | 99.61 | 99.53 | 99.11 | 98.30 | 98.10 |
| Insolubles | 0.39 | 0.47 | 0.89 | 1.70 | 1.90 |
| Non-Tans | 66.60 | 47.43 | 45.53 | 36.25 | 34.14 |
| Tannins | 33.01 | 52.10 | 53.58 | 62.05 | 63.96 |

### Example 2

### Determination Of Functional Limits For Alcohol Fractionation And Tannins Recovery Method And System

This experiment was made in an attempt to determine how various parameters might influence recovery yields of Super ReTan using isopropyl alcohol extraction. We explored the effect of the following parameters: a.) ReTan solids content; b.) isopropanl/ReTan volume ratio used in the separation; and, c.) Separation time on Super ReTan yields.

Based on Westfield's more than 15 years of experience with the tannery's triple-effect evaporator, and its operational limits in concentrating spent color bath product, it was decided that ReTan liquor in the 15-40% solids range was the viable starting point for this trial. Therefore, the experimental design called for starting samples with 15, 25, 30, 35, and 40% solids. The starting material for each sample was ReTan liquor at 29.5% solids, and samples were made by dilution or evaporation. The sample solutions were heated in a water bath at approximately 60° C. and shaken vigorously in an attempt to keep as much solids in solution as possible. The target and actual solids contents (weight/weight basis) are given in Table 2. In an attempt to simulate the azeotrope that would be obtained from a simple distillation recovery of isopropyl alcohol (IPA), 440 ml of isopropyl alcohol was combined with 60 ml of water to produce the standard 88:12 (alcohol:water) form. Next 200 ml of the above five described ReTan solutions were placed into a 500 ml separatory funnel and then either 100, 150, or 200 ml of the isopropyl alcohol solution was added. The suspension was shaken for approximately two minutes and then the phase separation was allowed to develop for 15, 30 or 90 minutes before a separation of the two fractions was made. The volumes of the aqueous (lower) and alcohol (upper) phases was measured in a 250 ml graduated cylinder. Approximately 5 grams of each solution was placed in a tared aluminum dish and weight measurements were taken before and after drying over night in an oven at 105° C. Next the density (specific gravity) of each sample was measured, and the amount of isopropyl alcohol(azeotrope) determined by distillation. After distillation, the measurements for density, and solids content of each sample was repeated.

TABLE 2
Target and Actual Solids Contents of Liquors

| Target % Solids | Actual % Solids |
|---|---|
| 15 | 17.8 |
| 25 | 25.5 |
| 30 | 29.5 |
| 35 | 36.6 |
| 40 | 41.6 |

The results (Tables 3-8) indicated that variations in the standing time (15-90 min) to allow phase separation had little effect on volumes or yields of the two phases. Therefore, in all following trials separation time was discontinued as a controlling variable. In this trial, after measurements of the 25% and 30% solids samples were completed, the three standing time samples for the 35% liquor were composited to minimize unnecessary labor. The ReTan at 15% solids content appeared to have significant amounts of the phosphate salts and water in the isopropyl alcohol fraction. This was apparent visually and can be seen in the higher yields of IPA-solubles. Working with the 40% solids content ReTan proved difficult because of the comparatively large amounts of insoluble materials in the water-soluble fraction. It also took considerable operator attention at the tannery to run the triple effect evaporator at its upper limit to produce the 40% solids material. Therefore, ReTan at 40% and 15% solids were eliminated as potential starting materials, and all future efforts centered on the 25% to 35% solids ReTan liquor. Table 3 provides a summary of the tannin recovery efficiencies of the various combinations tested. It appeared that the 25% to 30% solids ReTan had higher recover efficiencies than the 35% solids. Additionally, there did not appear to be an appreciable decline in recovery efficiencies at lower alcohol to ReTan ratios. Surprisingly, one pays only a small price in lower yields of isopropyl alcohol soluble materials by reducing the amount of alcohol used in the separation process by one-half.

In the 25% and 30% solids ReTan starting liquor, yields of active tannin material recovered dropped from 83.3% to 80.2% and 93.5% to 72.3%, respectively, when reducing the amount isopropyl alcohol used in the extraction by one-half. In a full scale system this would correspond to a reduction in the total amount of isopropyl alcohol used and recovered in the separation/fractionation process by 1,500 gal/day (5,678 l/day). This reduced processing requirement results in a significantly smaller recovery system with a correspondingly lower initial capital cost and annual operating budget from the energy savings. This trial was designed to explore the relationship between what were believed to be the three controlling variables (solids content, alcohol/ReTan mix ratio, and phase separation time), and no statistical analysis was attempted on these results that included only one replication per condition. In order to fully assess the significant economic implication of how this recovery system will be designed and operated, it was decided to repeat this trial with six replications of the most promising set-ups. The results of those experiments are described in Example 6 herein.

TABLE 3
Functional Limits Trial - Summary of Solids Recovery

| | Ratio of | | | | | | Average |
|---|---|---|---|---|---|---|---|
| Initial | IPA to | | | Total | | Percent | Percent |
| Total | ReTan | Settling | Resulting | Solids | Tannin | Tannin | Tannin |
| Solids | mixed | Time | Fraction | Recovered | Recovered | Recovered | Recovered |
| (%) | (vol:vol) | (min) | Type | (gm) | (gm) | (% of orig.) | (% of orig.) |
| 15% | 100:200 | 30 | alcohol | 28.3 | | | |
| 15% | 150:200 | 30 | alcohol | 24.7 | | | |
| 15% | 200:200 | 30 | alcohol | 22.4 | | | |
| 15% | 200:200 | 90 | alcohol | 22.7 | | | |
| 25% | 100:200 | 15 | alcohol | 19.9 | 9.8 | 74.3 | |
| 25% | 100:200 | 30 | alcohol | 17.9 | 9.0 | 67.8 | 72.3 |
| 25% | 100:200 | 90 | alcohol | 19.8 | 9.9 | 74.7 | |
| 25% | 150:200 | 15 | alcohol | 20.7 | 11.0 | 83.0 | |
| 25% | 150:200 | 30 | alcohol | 20.2 | 10.7 | 80.9 | 86.2 |
| 25% | 150:200 | 90 | alcohol | 23.6 | 12.5 | 94.6 | |
| 25% | 200:200 | 15 | alcohol | 25.3 | 13.5 | 102.2 | |
| 25% | 200:200 | 30 | alcohol | 22.8 | 12.2 | 92.3 | 93.5 |
| 25% | 200:200 | 90 | alcohol | 20.9 | 11.4 | 85.9 | |
| 30% | 100:200 | 15 | alcohol | 22.1 | 12.7 | 79.4 | |
| 30% | 100:200 | 30 | alcohol | 21.9 | 12.8 | 80.4 | 80.2 |
| 30% | 100:200 | 90 | alcohol | 21.8 | 12.9 | 80.7 | |
| 30% | 150:200 | 15 | alcohol | 21.7 | 12.6 | 79.1 | |
| 30% | 150:200 | 30 | alcohol | 21.4 | 12.8 | 80.1 | 79.8 |
| 30% | 150:200 | 90 | alcohol | 21.5 | 12.8 | 80.1 | |
| 30% | 200:200 | 15 | alcohol | 22.6 | 12.5 | 78.3 | |
| 30% | 200:200 | 30 | alcohol | 23.0 | 13.3 | 83.1 | 83.3 |
| 30% | 200:200 | 90 | alcohol | 24.4 | 14.1 | 88.5 | |
| 35% | 100:200 | 90 | alcohol | 23.6 | 8.0 | 39.0 | 39.0 |
| 35% | 150:200 | 90 | alcohol | 25.4 | 15.2 | 74.5 | 74.5 |
| 35% | 200:200 | 90 | alcohol | 22.7 | 13.4 | 65.6 | 65.6 |
| 40% | 100:200 | 30 | alcohol | 28.3 | | | |
| 40% | 150:200 | 30 | alcohol | 24.7 | | | |
| 40% | 200:200 | 30 | alcohol | 22.4 | | | |

TABLE 4
Functional Limits Trial - ReTan at 15% Solids Data

Initial Volume of ReTan = 200 ml
Initial Percent Solids = 17.8%
Initial Density = 1.11 (gm/ml)
Initial Total Solids = 39.5 gm
Initial active Tannins = 22%

| | | | | Meas- | Volume | | | | | Total | | | | Percent |
|---|---|---|---|---|---|---|---|---|---|---|---|---|---|---|
| Ratio of | | | | ured | recovery | Solids | Total | Solids | Net | Re- | IPA | | | Tannin |
| IPA to | | | Volume | Volume | of | Content | Recov- | recov- | Volume | cov- | recov- | Active* | Tannin | Recov- |
| ReTan | Settling | Resulting | of | sum of | Fractions | of | ered | ery | of | ered | ery | Tannin | Recov- | ered |
| mixed | Time | Fraction | Fraction | 2 parts | (% of | Fraction | Solids | (% of | Distillate | IPA | (% of | Content | ered | (% of |
| (vol:vol) | (min) | Type | (ml) | (ml) | total) | (gm) | (gm) | total) | (ml) | (gm) | total) | (%) | (lb) | orig.) |
| 100:200 | 15 | Water | 52 | 297.0 | 99.0 | 8.3 | 38.1 | 96.4 | | | | | | |
| | | Alcohol | 245 | | | 29.7 | | | | | | | | |
| 100:200 | 30 | Water | 56 | 296.0 | 98.7 | 9.0 | 36.6 | 92.7 | | | | | | |
| | | Alcohol | 240 | | | 27.6 | | | | | | | | |
| 100:200 | 90 | Water | 59 | 291.0 | 97.0 | 9.2 | 36.9 | 93.3 | | | | | | |
| | | Alcohol | 232 | | | 27.6 | | | | | | | | |
| 150:200 | 15 | Water | 46 | 344.0 | 98.3 | 15.7 | 40.7 | 103.1 | | | | | | |
| | | Alcohol | 298 | | | 25.0 | | | | | | | | |
| 150:200 | 30 | Water | 56 | 344.0 | 98.3 | 15.0 | 37.4 | 94.7 | | | | | | |
| | | Alcohol | 288 | | | 22.4 | | | | | | | | |
| 150:200 | 90 | Water | 47 | 344.0 | 98.3 | 16.1 | 42.8 | 108.3 | | | | | | |
| | | Alcohol | 297 | | | 26.7 | | | | | | | | |
| 200:200 | 15 | Water | 50 | 396.0 | 99.0 | 18.9 | 42.9 | 108.7 | | | | | | |
| | | Alcohol | 346 | | | 24.0 | | | | | | | | |
| 200:200 | 30 | Water | 57 | 389.0 | 97.3 | 20.0 | 40.3 | 102.0 | | | | | | |
| | | Alcohol | 332 | | | 20.4 | | | | | | | | |
| 200:200 | 90 | Water | 50 | 394.0 | 98.5 | 19.4 | 42.1 | 106.5 | | | | | | |
| | | Alcohol | 344 | | | 22.7 | | | | | | | | |

TABLE 5
Functional Limits Trial - ReTan at 25% Solids Data

Initial Volume of ReTan = 200 ml
Initial Percent Solids = 25.5 ml
Initial Density = 1.18 ml
Initial Total Solids = 60.2 ml
Initial active Tannins = 22%

| | | | | Meas- | Volume | | | | | Total | | | | Percent |
|---|---|---|---|---|---|---|---|---|---|---|---|---|---|---|
| Ratio of | | | | ured | recovery | Solids | Total | Solids | Net | Re- | IPA | | | Tannin |
| IPA to | | | Volume | Volume | of | Content | Recov- | recov- | Volume | cov- | recov- | Active* | Tannin | Recov- |
| ReTan | Settling | Resulting | of | sum of | Fractions | of | ered | ery | of | ered | ery | Tannin | Recov- | ered |
| mixed | Time | Fraction | Fraction | 2 parts | (% of | Fraction | Solids | (% of | Distillate | IPA | (% of | Content | ered | (% of |
| (vol:vol) | (min) | Type | (ml) | (ml) | total) | (gm) | (gm) | total) | (ml) | (gm) | total) | (%) | (lb) | orig.) |
| 100:200 | 15 | Water | 131 | 297.0 | 99.0 | 39.7 | 59.5 | 98.9 | 15 | 89.0 | 89.0 | 2.92 | 1.2 | |
| | | Alcohol | 166 | | | 19.9 | | | 74 | | | 49.51 | 9.8 | 74.3 |
| 100:200 | 30 | Water | 132 | 297.0 | 99.0 | 40.8 | 58.7 | 97.6 | 15 | 88.0 | 88.0 | 5.70 | 2.3 | |
| | | Alcohol | 165 | | | 17.9 | | | 73 | | | 50.00 | 9.0 | 67.8 |
| 100:200 | 90 | Water | 133 | 295.0 | 98.3 | 39.6 | 59.5 | 98.8 | 17.1 | 88.1 | 88.1 | 6.59 | 2.6 | |
| | | Alcohol | 162 | | | 19.8 | | | 71 | | | 49.95 | 9.9 | 74.7 |
| 150:200 | 15 | Water | 120 | 346.0 | 98.9 | 39.0 | 59.7 | 99.2 | 12.9 | 136.9 | 91.3 | 1.76 | 0.7 | |
| | | Alcohol | 226 | | | 20.7 | | | 124 | | | 53.18 | 11.0 | 83.0 |
| 150:200 | 30 | Water | 119 | 343.0 | 98.0 | 39.8 | 60.0 | 99.7 | 13.1 | 126.1 | 84.1 | 4.63 | 1.8 | |
| | | Alcohol | 224 | | | 20.2 | | | 113 | | | 53.00 | 10.7 | 80.9 |
| 150:200 | 90 | Water | 120 | 342.0 | 97.7 | 43.4 | 66.9 | 111.2 | 12 | 134.0 | 89.3 | 5.78 | 2.5 | |
| | | Alcohol | 222 | | | 23.6 | | | 122 | | | 53.19 | 12.5 | 94.6 |
| 200:200 | 15 | Water | 115 | 393.0 | 98.3 | 42.8 | 68.1 | 113.2 | 12.4 | 168.4 | 84.2 | 1.91 | 0.8 | |
| | | Alcohol | 278 | | | 25.3 | | | 156 | | | 53.43 | 13.5 | 102.2 |
| 200:200 | 30 | Water | 114 | 392.0 | 98.0 | 43.0 | 65.7 | 109.3 | 12.7 | 181.7 | 90.9 | 0.76 | 0.3 | |
| | | Alcohol | 278 | | | 22.8 | | | 169 | | | 53.69 | 12.2 | 92.3 |
| 200:200 | 90 | Water | 116 | 391.0 | 97.8 | 42.9 | 63.8 | 106.0 | 13.2 | 178.2 | 89.1 | 5.05 | 2.2 | |
| | | Alcohol | 275 | | | 20.9 | | | 165 | | | 54.31 | 11.4 | 85.9 |

TABLE 6
Functional Limits Trial - ReTan at 30% Solids Data

Initial Volume of ReTan = 200 ml
Initial Percent Solids = 29.5%
Initial Density = 1.23 (gm/ml)
Initial Total Solids = 72.6 gm
Initial active Tannins = 22%

| | | | | Meas- | Volume | | | | | Total | | | | Percent |
|---|---|---|---|---|---|---|---|---|---|---|---|---|---|---|
| Ratio of | | | | ured | recovery | Solids | Total | Solids | Net | Re- | IPA | | | Tannin |
| IPA to | | | Volume | Volume | of | Content | Recov- | recov- | Volume | cov- | recov- | Active* | Tannin | Recov- |
| ReTan | Settling | Resulting | of | sum of | Fractions | of | ered | ery | of | ered | ery | Tannin | Recov- | ered |
| mixed | Time | Fraction | Fraction | 2 parts | (% of | Fraction | Solids | (% of | Distillate | IPA | (% of | Content | ered | (% of |
| (vol:vol) | (min) | Type | (ml) | (ml) | total) | (gm) | (gm) | total) | (ml) | (gm) | total) | (%) | (lb) | orig.) |
| 100:200 | 15 | Water | 142 | 295.0 | 98.3 | 51.3 | 73.4 | 101.2 | 11.4 | 88.4 | 88.4 | 3.68 | 1.9 | |
| | | Alcohol | 153 | | | 22.1 | | | 77 | | | 57.40 | 12.7 | 79.4 |
| 100:200 | 30 | Water | 143 | 296.0 | 98.7 | 52.1 | 74.0 | 102.0 | 11.4 | 87.4 | 87.4 | 6.83 | 3.6 | |
| | | Alcohol | 153 | | | 21.9 | | | 76 | | | 58.67 | 12.8 | 80.4 |
| 100:200 | 90 | Water | 142 | 295.0 | 98.3 | 53.0 | 74.8 | 103.0 | 11.6 | 89.6 | 89.6 | 5.59 | 3.0 | |
| | | Alcohol | 153 | | | 21.8 | | | 78 | | | 59.07 | 12.9 | 80.7 |
| 150:200 | 15 | Water | 145 | 344.0 | 98.3 | 55.1 | 76.8 | 105.8 | 16.6 | 132.6 | 88.4 | 5.57 | 3.1 | |
| | | Alcohol | 199 | | | 21.7 | | | 116 | | | 58.16 | 12.6 | 79.1 |
| 150:200 | 30 | Water | 140 | 343.0 | 98.0 | 54.7 | 76.1 | 104.8 | 13.4 | 134.4 | 89.6 | 3.86 | | |
| | | Alcohol | 203 | | | 21.4 | | | 121 | | | 59.88 | 12.8 | 80.1 |
| 150:200 | 90 | Water | 133 | 345.0 | 98.6 | 51.5 | 73.0 | 100.6 | 10.6 | 132.6 | 88.4 | 0.00 | | |
| | | Alcohol | 212 | | | 21.5 | | | 122 | | | 59.56 | 12.8 | 80.1 |
| 200:200 | 15 | Water | 119 | 397.0 | 99.3 | 49.7 | 72.2 | 99.5 | 6 | 182.0 | 91.0 | 2.81 | 1.4 | |
| | | Alcohol | 278 | | | 22.6 | | | 176 | | | 55.45 | 12.5 | 78.3 |
| 200:200 | 30 | Water | 118 | 396.0 | 99.0 | 48.8 | 71.8 | 98.9 | 9.2 | 185.2 | 92.6 | 0.00 | 0.0 | |
| | | Alcohol | 278 | | | 23.0 | | | 176 | | | 57.65 | 13.3 | 83.1 |
| 200:200 | 90 | Water | 118 | 396.0 | 99.0 | 46.4 | 70.8 | 97.6 | 8.8 | 185.8 | 92.9 | 0.13 | 0.1 | |
| | | Alcohol | 278 | | | 24.4 | | | 177 | | | 57.97 | 14.1 | 88.5 |

TABLE 7
Functional Limits Trial - ReTan at 35% Solids Data

Initial Volume of ReTan = 200 ml
Initial Percent Solids = 36.6%
Initial Density = 1.27 (gm/ml)
Initial Total Solids = 93.0 gm
Initial active Tannins = 22%

| | | | | Meas- | Volume | | | | | Total | | | | Percent |
|---|---|---|---|---|---|---|---|---|---|---|---|---|---|---|
| Ratio of | | | | ured | recovery | Solids | Total | Solids | Net | Re- | IPA | | | Tannin |
| IPA to | | | Volume | Volume | of | Content | Recov- | recov- | Volume | cov- | recov- | Active* | Tannin | Recov- |
| ReTan | Settling | Resulting | of | sum of | Fractions | of | ered | ery | of | ered | ery | Tannin | Recov- | ered |
| mixed | Time | Fraction | Fraction | 2 parts | (% of | Fraction | Solids | (% of | Distillate | IPA | (% of | Content | ered | (% of |
| (vol:vol) | (min) | Type | (ml) | (ml) | total) | (gm) | (gm) | total) | (ml) | (gm) | total) | (%) | (lb) | orig.) |
| 100:200 | 15 | Water | 152 | 298.0 | 99.3 | 68.4 | 93.3 | 100.4 | | | | | | |
| | | Alcohol | 146 | | | 24.9 | | | | | | | | |
| 100:200 | 30 | Water | 153 | 298.0 | 99.3 | 68.4 | 91.9 | 98.9 | 8.2 | 88.2 | 88.2 | 4.44 | 3.0 | |
| | | Alcohol | 145 | | | 23.6 | | | 80 | | | 33.85 | 8.0 | 39.0 |
| 100:200 | 90 | Water | 156 | 297.0 | 99.0 | 69.4 | 92.3 | 99.3 | | | | | | |
| | | Alcohol | 141 | | | 22.9 | | | | | | | | |
| 150:200 | 15 | Water | 154 | 348.0 | 99.4 | 71.8 | 96.9 | 104.2 | | | | | | |
| | | Alcohol | 194 | | 25.1 | | | | | | | | | |
| 150:200 | 30 | Water | 145 | 343.0 | 98.0 | 69.5 | 94.9 | 102.1 | 8.1 | 134.1 | 89.4 | 6.03 | 4.2 | |
| | | Alcohol | 198 | | | 25.4 | | | 126 | | | 59.99 | 15.2 | 74.5 |
| 150:200 | 90 | Water | 146 | 343.0 | 98.0 | 74.6 | 100.3 | 107.9 | | | | | | |
| | | Alcohol | 197 | | | 25.7 | | | | | | | | |
| 200:200 | 15 | Water | 154 | 394.0 | 98.5 | 77.0 | 100.8 | 108.4 | | | | | | |
| | | Alcohol | 240 | | | 23.8 | | | | | | | | |
| 200:200 | 30 | Water | 144 | 390.0 | 97.5 | 73.3 | 96.1 | 103.4 | 10.2 | 180.2 | 90.1 | 4.49 | 3.3 | |
| | | Alcohol | 246 | | | 22.7 | | 170 | | | 58.97 | 13.4 | 65.6 | |
| 200:200 | 90 | Water | 141 | 391.0 | 97.8 | 69.2 | 93.8 | 100.9 | | | | | | |
| | | Alcohol | 250 | | | 24.5 | | | | | | | | |

TABLE 8
Functional Limits Trial - ReTan at 40% Solids Data

Initial Volume of ReTan = 200 ml
Initial Percent Solids = 41.6%
Initial Density = 1.29 (gm/ml)
Initial Total Solids = 107.3 gm
Initial active Tannins = 22%

| | | | | Meas- | Volume | | | | | Total | | | | Percent |
|---|---|---|---|---|---|---|---|---|---|---|---|---|---|---|
| Ratio of | | | | ured | recovery | Solids | Total | Solids | Net | Re- | IPA | | | Tannin |
| IPA to | | | Volume | Volume | of | Content | Recov- | recov- | Volume | cov- | recov- | Active* | Tannin | Recov- |
| ReTan | Settling | Resulting | of | sum of | Fractions | of | ered | ery | of | ered | ery | Tannin | Recov- | ered |
| mixed | Time | Fraction | Fraction | 2 parts | (% of | Fraction | Solids | (% of | Distillate | IPA | (% of | Content | ered | (% of |
| (vol:vol) | (min) | Type | (ml) | (ml) | total) | (gm) | (gm) | total) | (ml) | (gm) | total) | (%) | (lb) | orig.) |
| 100:200 | 15 | Water | 163 | 296.0 | 98.7 | 78.9 | 102.6 | 95.6 | | | | | | |
| | | Alcohol | 133 | | | 23.7 | | | | | | | | |
| 100:200 | 30 | Water | 158 | 290.0 | 96.7 | 80.9 | 104.3 | 97.2 | | | | | | |
| | | Alcohol | 132 | | | 23.4 | | | | | | | | |
| 100:200 | 90 | Water | 166 | 293.0 | 97.7 | 85.2 | 110.5 | 102.9 | | | | | | |
| | | Alcohol | 127 | | | 25.2 | | | | | | | | |
| 150:200 | 15 | Water | 162 | 344.0 | 98.3 | 81.4 | 105.4 | 98.2 | | | | | | |
| | | Alcohol | 182 | | | 24.0 | | | | | | | | |
| 150:200 | 30 | Water | 158 | 346.0 | 98.9 | 85.8 | 113.4 | 105.7 | | | | | | |
| | | Alcohol | 188 | | 27.7 | | | | | | | | | |
| 150:200 | 90 | Water | 153 | 341.0 | 97.4 | 83.1 | 109.3 | 101.9 | | | | | | |
| | | Alcohol | 188 | | | 26.3 | | | | | | | | |
| 200:200 | 15 | Water | 158 | 397.0 | 99.3 | 81.3 | 103.3 | 96.2 | | | | | | |
| | | Alcohol | 239 | | | 22.0 | | | | | | | | |
| 200:200 | 30 | Water | 156 | 395.0 | 98.8 | 80.1 | 108.2 | 100.8 | | | | | | |
| | | Alcohol | 239 | | | 28.2 | | | | | | | | |
| 200:200 | 90 | Water | 150 | 392.0 | 98.0 | 86.3 | 111.4 | 103.8 | | | | | | |
| | | Alcohol | 242 | | | 25.1 | | | | | | | | |

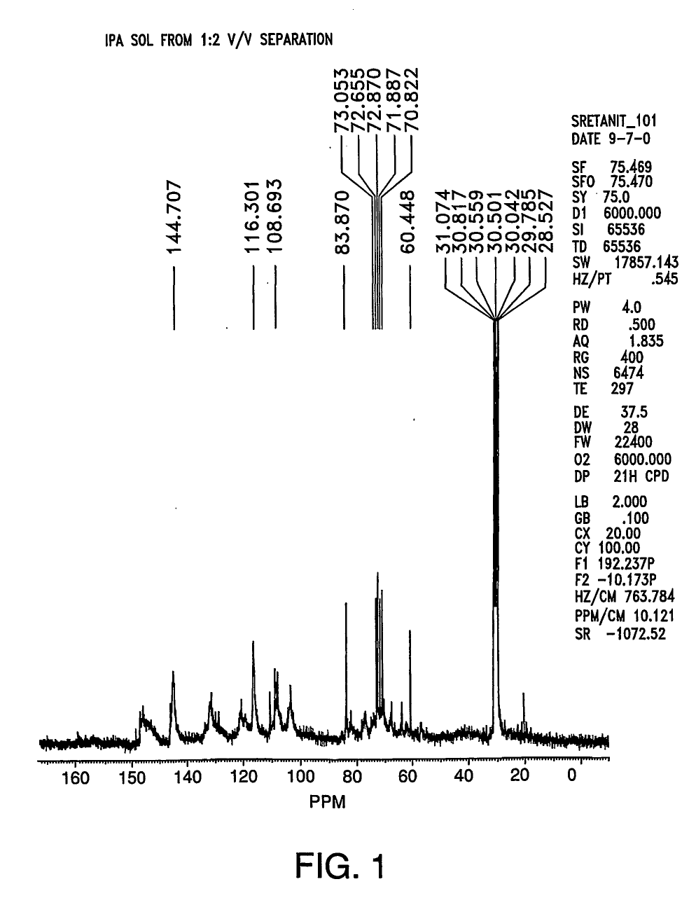

This experiment showed that the presence of high concentrations of phosphate salts in the spent liquor results in an unexpected clean phase separation of the isopropyl alcohol and water-soluble fractions with a significant difference in specific gravities between the top alcohol fraction and the bottom aqueous fraction, 0.93 and 1.24, respectively, making phase separation quick and visually apparent (FIG. 1). A batch type process provides superior phase separation, but approximately 15 minutes of phase separation time appears to be sufficient. Based on the results, the optimum range for the ReTan solids content of the starting material is 25% to 35% (wt/wt).

Next, the effect of reducing the amount of isopropyl alcohol used in the separations was undertaken on the theory that small losses in yield may well be economically and environmentally offset by reduction in the size of the alcohol recovery system and the amount of isopropyl alcohol used in the fractionation. The inventor felt that, once optimal operating conditions are established, a large sample of that SuperReTan should be produced for evaluation in leather manufacture. Furthermore, it was desired that any alcohol in the aqueous fraction be recovered from the water-soluble fraction in order to make the method environmentally acceptable. Alcohol recovery from the two fractions would be best accomplished using different systems for the “top” and “bottom” fractions tailored to the liquors specific physical characteristics. This method will also simplify operation and reduce the likelihood of operator errors.

### Example 3

### Leather Production Trial

Previous trials had proven that tannins with near virgin material levels of active plant polyphenols were effectively reclaimed with the alcohol fractionation and recovery method. To test the usefulness of the recovered tannins, a significant quantity of leather needed to be produced using standard industry practices. Towards this end, two batches of 30 gallons each (114 liters) of SuperReTan were produced at a large industrial evaporator vendors test laboratory. Two separate 40 gallon drums of 30% solids ReTan liquor were mixed at a 2:1 ratio with isopropyl alcohol and allowed to stand for 30 minutes. Alcohol and aqueous fractions were separated by decanting with the phase break determined by simple visual color cues. The “top” alcohol-soluble fraction was processed in a counter current falling film evaporator and the isopropyl alcohol was recovered as the distillate with the SuperReTan as the residue. All operating conditions except for temperature, as controlled by the amount of vacuum maintained on the column, were kept the same in the evaporator between the trials. Operationally, the tannins cannot be exposed to temperatures over 170° F. or they will begin to oxidize and loose their effectiveness as tanning agents. In the these two trials, the evaporator was operated at reduced pressures of 150, and 250 mm Hg and SuperReTan was recovered at product temperatures not exceeding 120° F. and 135° F., respectively. Temperature of the product was also controlled by regulating the flow (residence time). The SuperReTan from this test was brought to the Westfield Tanning Company's facility and analyzed for active tannin content (hide powder) and other standard parameters (Table 9). Based on early results, it was anticipated that at the most SuperReTan could replace 16% of the daily tannin use (total is approximately 19,000 lbs. per day of active tannin). For this trial a worst case scenario was used to try and illuminate any deficiencies in the SuperReTan so hides were tanned in a mix of 75 percent Yard Blend (aqueous mixture of 68% quebracho (spray dried or solid), 30% spray dried wattle, and 2% synthetic tannins (such as Syntan® or DLE-P from BASF Corp.) and 25 percent SuperReTan on a vol:vol ratio. For this trial three sides were chosen on normal production days at random from the tanyard floor after having received standard pre-tanning preparation (dehair, bate, color etc . . . ). These hides from the color vats were brought into the quality control lab and the Tanyard Supervisor, and Senior Tanning Chemist set up and operated a 160 gallon scaled tanning vat for two, 14 day production trials. This initial blend and daily make up liquor were diluted to maintain 12% tannin as in Westfield's standard LIRITAN process. This process was repeated with the second batch of SuperReTan (labeled Super ReTan 3rd lot in Table 9).

TABLE 9
Starting SuperReTan Analysis for Leather Production Trial

| | Super ReTan 2nd lot | Super ReTan 3rd lot |
|---|---|---|
| Total Percent Solids | 31.6 | 31.8 |
| Insolubles | 0.58 | 0.63 |
| Non-Tannin | 6.62 | 6.58 |
| Tannin | 24.4 | 24.1 |
| pH | 3.4 | 3.4 |
| Purity | 78.66 | 77.10 |
| Tannin (dry) | 77.22 | 75.79 |

Leather samples were removed from the pilot vat and allowed to air dry to standard moisture content before physical property testing. Three samples were taken from one hide randomly selected from each tanning batch for measurement of physical properties.

The largest surprise of this experimental trial was that the mix of SuperReTan and Yard Blend tanning liquor was found to penetrate the hide faster than the Yard Blend. This surprising result could result in an unexpected economic benefit for vegetable leather tanneries through reduced production time, increased production capacity with the same facility, and reduced inventory time. Penetration is normally checked by examining hide cross sections, and the samples in the pilot tanning vat were found to tan 15-20 percent quicker. The physical testing of all samples measured showed the SuperReTan/Yard Blend mix produced a leather which shows acceptable break force, tensile strength, and resistance to elongation. Results are shown in Table 10. Leather produced in an industry standard 12% active tannin Yard Blend liquor that was composed of 25% SuperReTan (on a volume basis) produced a finished product that met industry strength standards and had physical appearance and workability properties that were indistinguishable from our standard product.

TABLE 10
Leather Production Trial
Break force, Tensile Strength & Elongation: Test Results

| | | | | | Elong. @ | |
|---|---|---|---|---|---|---|
| Sample | Thick- | | Break | Tensile | 100 lbs | |
| # | ness | Width | force | Strength | of Load | Comment |
| 1 | 0.210 | 0.500 | 375 lbs | 3571.4 psi | 12.40% | Passed |
| 2 | 0.227 | 0.500 | 312 lbs | 2748.9 psi | 13.10% | Passed |
| 3 | 0.242 | 0.500 | 250 lbs | 2066.1 psi | 11.70% | Passed |
| 4 | 0.212 | 0.500 | 350 lbs | 3301.9 psi | 12.30% | Passed |
| 5 | 0.227 | 0.500 | 295 lbs | 2599.1 psi | 11.40% | Passed |
| 6 | 0.207 | 0.500 | 312 lbs | 3014.5 psi | 13.60% | Passed |

REQUIREMENTS
Break force: Minimum of 200 lbs with ½″ wide sample
Tensile Strength: Minimum of 2000 psi with ½″ wide sample
Elongation: Maximum of 15.0%

### Example 4

### Novelty Of IPA Fractionation Method For ReTan Proven By Attempts To Fractionate Virgin Tannins With Other Salts

The faster penetration of the SuperReTan as compared with our yard mix into our comparatively thick hides caught our attention. If we could more rapidly accomplish vegetable tanned thick leather manufacture for shoe sole, harness, or saddle leather products we could substantially increase the productivity of vegetable tanning leather manufacturing plants that use plant polyphenols as the primary tanning agent for leather manufacture. We therefore examined the possibility that we might increase the rate of the tanning through use of the recovered SuperReTan and virgin tannins processed in a similar method with alcohol fractionation (Super virgin tanns). The resulting SuperReTan and Super virgin tannin blend tannin time was then to be compared with the Yard Blend.

The Yard Blend, at a solids content of 51.9% was diluted in half with water to provide 3 liters of a 36.2% solids solution with a density of 1.162 gm/ml. This diluted Yard Blend was then used in this fractionation study. One liter of the diluted Yard Blend was combined with 1 liter of isopropyl alcohol (Run A). In a second trial, one liter of the diluted Yard Blend was combined with 1.35 L of the isopropyl alcohol azeotrope (88% alcohol and 12% water (Run B). In an effort to try to force phase separation, NaCl at 5% and 10% (w/v) was added before extracting with isopropyl alcohol (Run C). Finally an additional 10 gm of NaCl was added to each of the above solutions to give 15% and 20% (w/v) salt concentration (Run D).

No phase separation occurred in Runs A or B. The mixtures were decanted, filtered and the isopropyl alcohol was recovered by distillation. We recovered 26.6 gm (6.3%) and 35.3 (8.4%) of precipitate from Runs A and B, respectively. We recovered 830 ml of a 40.6% (1.155 gm/ml) solution from Run A and 945 ml of a 37.0% (1.138 gm/mL) solution from Run B and sent a sample of this product for tannin analysis. Addition of NaCl in Runs C and D did not affect phase separation of an IPA/aqueous mixture as was seen in mixtures of the high phosphate salt-containing spent liquor.

The failure to obtain phase separation of the isopropyl alcohol in these trials, even after addition of up to 20% of NaCl, highlights the novelty of this isopropyl alcohol fractionation process for recovery of tannin from the spent ReTan liquor. This novelty is further illustrated in Example 9 where use of the high phosphate aqueous layer from alcohol fractionation of ReTan does allow for fractionation of bisulfited virgin tannins with isopropyl alcohol.

### EXAMPLE 5

### Example Evaluation Of The Structure Of Recovered Tannins By ¹³C NMR Analysis

Given the difference between SuperReTan and the virgin yard mix in hide penetration rate, the inventor desired to more thoroughly explore the chemistry of SuperReTan. We used ¹³C NMR spectral analyses in and attempt to explain the differences between SuperReTan and virgin Yard Blend tannins (FIG. 1).

Freeze-dried samples were dissolved in d6-acetone with a small amount of D₂O and ¹³C spectra were recorded using a Bruker AC-300 spectrometer. In analyzing spectra of the recovered SuperReTan, we noted the presence of some residual isopropyl alcohol as evident from the sharp signals at 24.99 and 64.49 ppm. That result alerted us to carefully address the question of isopropyl alcohol recovery from either the alcohol fraction or the water-soluble fraction. In addition, we see a series of carbon resonances that have chemical shifts indicative of carbohydrates that appear in the range of 60-83 ppm. These same carbohydrate signals were observed in ¹³C NMR spectra obtained from a sample of wattle tannin as well as the Yard Blend (data not shown). Although these resonances are most evident, they do not represent the majority of the sample because those signals are extremely sharp and representative of small molecules in comparison with the tannin signals that are seen in the spectra.

The spectra seen for the tannin recovered using the three different tannin to isopropyl alcohol ratios look very similar. The spectra are messy in comparison to what one sees in analysis of purified compounds but are surprisingly sharp for industrial products. According to work summarized by Roux, a mixture of partially sulfonated wattle and quebracho tannins is represented by the structure shown in FIG. 2.

See, Roux, D. G. “Reflections on the chemistry and affinities of the major commercial condensed tannins in the context of their industrial use” in Hemingway, R. W. and Laks, P. E. (eds.) Plant Polyphenols. Synthesis, Properties. Significance. Plenum Press, N.Y. pp. 7-39, 1992.

A prorobinetinidin unit represented by the IJK unit has the appropriate absolute stereochemistry and hydroxylation pattern for a wattle tannin. Quebracho tannin differs from wattle tannin in having the opposite absolute stereochemistry as shown for the unit. Both wattle and quebracho tannins are typically angular with substitution at both the C6 and C8 of a terminal catechin unit as shown in FGH unit. In marked contrast to the procyanidins and prodelphinidins found in pine bark or pecan tannins, sulfonation of wattle or quebracho tannins results in opening of the pyran ring with substitution at C2 as shown in the ABC unit shown in FIG. 2, with the substitution at C8 of the C-ring for convenience in drawing all these structures. One would expect further substitution of the prorobinetindins and profisetinidin units at the 6 rather than at 8 because of differences in steric hindrance.

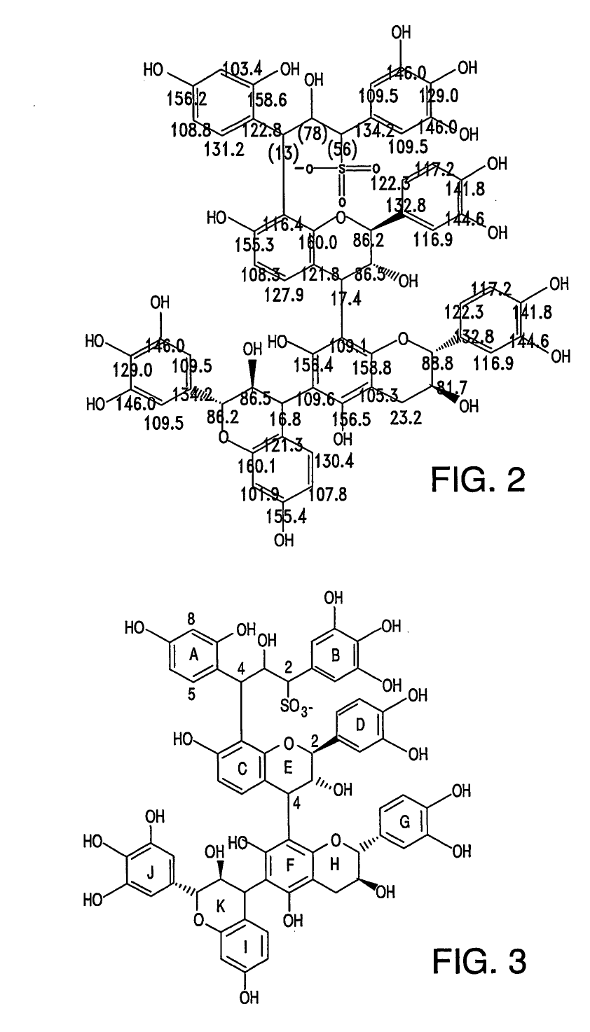

The inventor used the NMR chemical shift estimation program in ChemDraw software to compute the expected chemical shifts for the structure shown in FIG. 3. Most of the resonances seen in the spectra of the SuperReTan sample (FIG. 1) are reasonably consistent with the ¹³C chemical shifts that would be expected from the structure in FIG. 3.

### Example 6

### Optimization Of Operating Conditions (Statistical Analysis)

In an effort to obtain more precise information about the optimal spent liquor solids content and ratio of isopropyl alcohol to use in these separations, another series of separations on a composite sample made up from three samples of ReTan liquor produced 2 weeks apart (see Table 15 for starting tannin analysis of ReTan liquor samples). Six replications were made of each combination using two different percent solids and three alcohol mix ratios for a total of 36 samples. The results of that series of experiments are given in Tables 11-14. A standard analysis of variance (ANOVA) for this randomized complete block design experiment is presented in Table 14. At the 95% confidence interval it was determined that there was no significant difference between starting with ReTan Liquor at 27% and 34% solids. From the previous trials, 40% solids liquor proved too difficult to work with. Combining data from these two trials indicates that the alcohol fractional process would be most economically operated with a starting liquor with a starting percent solids in the 32% to 36% solids range. The advantages to this result are extremely significant in terms of using smaller capacity (less expensive) alcohol recovery equipment and in reduced energy needed to “boil off” the lower volume of alcohol and ReTan in a more concentrated liquor.

Recovery efficiencies for what is considered the most economical set-up (involving use of the high solids content liquor and the low alcohol to ReTan ratio) were found to be between 87.25% and 93.5%. Using the Westfield Tannery as a baseline, at these recovery efficiencies nearly 650,000 lbs. per year of tannin with a 62% active tannin content (dry weight) would be recovered, assuming current production levels. Based on this multiple replication trial, we have identified and verified the optimum economic operating conditions for alcohol fractionation in a plant polyphenol recovery system.

TABLE 11
SuperReTan Fractionation - Multiple Replication Trial

Initial Volume of ReTan = 200 ml
Initial Percent Solids = 26.8% %
Initial Density = 1.1693 (gm/ml)
Initial Total Solids = 62.7 gm
Initial Active Tannins 21.3% %
Initial Active Tannins 13.3 gm

| | | | | | | | | | Distil- | “Super | | | | Percent |
|---|---|---|---|---|---|---|---|---|---|---|---|---|---|---|
| | | | | | “Top” | | | Alcohol | lation | ReTan” | | | Tannin | Tannin |
| IPA: | | “Bottom” | | | Initial | Initial | Alcohol | Volume | Re- | Re- | Re- | Active* | Re- | Re- |
| ReTan | | Aqueous | Aqueous | Aqueous | Alcohol | Alcohol | Volume | Re- | sidual | sidual | sidual | Tannin | cov- | covered |
| Ratio | Rep | Volume | Density | Solids % | Volume | Density | Distilled | covered | Volume | Density | % | Content | ered | (% of |
| (ml:ml) | # | (ml) | (gm/ml) | (%) | (ml) | (gm/ml) | (ml) | (ml) | (ml) | (gm/ml) | solids | (%) | (gm) | orig.) |
| 100:200 | 1 | 141 | | 25.8 | 154 | 0.9798 | 143 | 74 | 71 | 1.1184 | 25.0% | 55.8% | 10.94 | 82.0% |
| | 2 | 142 | 1.1858 | 26.2 | 158 | 0.9796 | 146 | 76 | 70 | 1.1228 | 25.6% | 56.2% | 11.65 | 87.3% |
| | 3 | 145 | 1.1822 | 26 | 156 | 0.9734 | 146 | 78 | 68 | 1.126 | 26.1% | 57.7% | 11.81 | 88.5% |
| | 4 | 141 | 1.1848 | 27 | 157 | 0.9753 | 148 | 78 | 71 | 1.1213 | 26.1% | 58.2% | 12.21 | 91.5% |
| | 5 | 144 | 1.1846 | 27.3 | 155 | 0.9733 | 146 | 75 | 70 | 1.1213 | 25.8% | 39.3% | 8.47 | 63.4% |
| | 6 | 145 | 1.1863 | 27.4 | 155 | 0.9788 | 144 | 77 | 67 | 1.1312 | 26.4% | 42.3% | 8.43 | 63.1% |
| 150:200 | 1 | 122 | | 28.3 | 224 | 0.9457 | 211 | 126 | 87 | 1.1007 | 22.5% | 58.2% | 12.55 | 94.0% |
| | 2 | 125 | 1.2108 | 28.8 | 223 | 0.9478 | 210 | 126 | 83 | 1.0909 | 22.9% | 59.0% | 12.41 | 93.0% |
| | 3 | 128 | 1.2097 | 27.9 | 220 | 0.9428 | 210 | 128 | 84 | 1.111 | 23.5% | 58.9% | 13.14 | 98.4% |
| | 4 | 125 | 1.2085 | 29.1 | 224 | 0.9406 | 213 | 131 | 85 | 1.1038 | 23.0% | 57.0% | 12.54 | 94.0% |
| | 5 | 127 | 1.2115 | 29.1 | 223 | 0.9421 | 213 | 129 | 83 | 1.1059 | 23.9% | 57.0% | 12.77 | 95.6% |
| | 6 | 127 | 1.2104 | 28.7 | 223 | 0.9457 | 212 | 131 | 82 | 1.1118 | 24.2% | 58.0% | 13.17 | 98.7% |
| 200:200 | 1 | 109 | | 30.2 | 285 | 0.9278* | 270 | 176 | 98 | 1.0918 | 20.7% | 59.8% | 13.20 | 98.9% |
| | 2 | 112 | 1.2393 | 30.9 | 286 | 0.9292 | 270 | 176 | 95 | 1.0941 | 21.3% | 57.5% | 12.81 | 95.9% |
| | 3 | 113 | 1.2339 | 30.4 | 287 | 0.926 | 275 | 179 | 96 | 1.0954 | 21.8% | 60.1% | 13.97 | 104.6% |
| | 4 | 112 | 1.2306 | 30.3 | 287 | 0.9245 | 274 | 178 | 96 | 1.0956 | 21.7% | 57.1% | 13.09 | 98.1% |
| | 5 | 114 | 1.2345 | 30.5 | 275 | 0.9242 | 272 | 176 | 93 | 1.0989 | 22.1% | 57.1% | 13.09 | 98.1% |
| | 6 | 115 | 1.2327 | 30.9 | 285 | 0.9265 | 270 | 178 | 93 | 1.0993 | 22.0% | 57.2% | 13.13 | 98.3% |

TABLE 12
SuperReTan Fractionation Multiple Replication Trial

Initial Volume of ReTan = 200 ml
Initial Percent Solids = 34.1% %
Initial Density = 1.2295 (gm/ml)
Initial Total Solids = 83.9 gm
Initial Active Tannins 21.3% %
Initial Active Tannins 17.9 gm

| | | | | | | | | | Distil- | “Super | | | | Percent |
|---|---|---|---|---|---|---|---|---|---|---|---|---|---|---|
| | | | | | “Top” | | | Alcohol | lation | ReTan” | | | Tannin | Tannin |
| IPA: | | “Bottom” | | | Initial | Initial | Alcohol | Volume | Re- | Re- | Re- | Active* | Re- | Re- |
| ReTan | | Aqueous | Aqueous | Aqueous | Alcohol | Alcohol | Volume | Re- | sidual | sidual | sidual | Tannin | cov- | covered |
| Ratio | Rep | Volume | Density | Solids % | Volume | Density | Distilled | covered | Volume | Density | % | Content | ered | (% of |
| (ml:ml) | # | (ml) | (gm/ml) | (%) | (ml) | (gm/ml) | (ml) | (ml) | (ml) | (gm/ml) | solids | (%) | (gm) | orig.) |
| 100:200 | 1 | 141 | 1.2483 | 32.2 | 150 | 0.9803 | 138 | 78 | 59 | 1.1764 | 35.9% | 62.3% | 15.58 | 116.7% |
| | 2 | 144 | 1.258 | 33 | 148 | 0.9802 | 142 | 81 | 58 | 1.1707 | 34.6% | 65.5% | 15.93 | 119.3% |
| | 3 | 154 | 1.2444 | 32.2 | 144 | 0.9737 | 136 | 80 | 54 | 1.1626 | 36.1% | 68.9% | 15.83 | 118.6% |
| | 4 | 144 | 1.2488 | 33 | 156 | 0.9814 | 145 | 84 | 61 | 1.176 | 35.7% | 62.9% | 16.08 | 120.5% |
| | 5 | 146 | 1.2508 | 33 | 154 | 0.9825 | 145 | 84 | 63 | 1.1682 | 34.9% | 62.9% | 16.69 | 125.0% |
| | 6 | 145 | 1.2516 | 34.2 | 155 | 0.9789 | 144 | 84 | 61 | 1.1734 | 35.2% | 62.9% | 16.31 | 122.1% |
| 150:200 | 1 | 134 | 1.2659 | 33.3 | 208 | 0.9469 | 198 | 128 | 69 | 1.1532 | 32.0% | 61.6% | 15.92 | 119.3% |
| | 2 | 136 | 1.2733 | 34.7 | 204 | 0.9418 | 198 | 130 | 68 | 1.1398 | 31.7% | 67.4% | 16.66 | 124.8% |
| | 3 | 140 | 1.266 | 33.9 | 206 | 0.9411 | 198 | 130 | 68 | 1.1418 | 32.1% | 67.6% | 16.96 | 127.1% |
| | 4 | 136 | 1.2647 | 34.4 | 212 | 0.9493 | 201 | 132 | 72 | 1.1526 | 32.2% | 48.2% | 13.31 | 99.7% |
| | 5 | 137 | 1.2695 | 34.5 | 214 | 0.9473 | 201 | 132 | 71 | 1.1482 | 32.1% | 62.2% | 16.74 | 125.4% |
| | 6 | 137 | 1.2675 | 34.9 | 212 | 0.9416 | 201 | 132 | 71 | 1.1498 | 31.8% | 61.7% | 16.34 | 122.4% |
| 200:200 | 1 | 145 | 1.2535 | 33.7 | 247 | 0.9195 | 237 | 166 | 69 | 1.1215 | 27.2% | 58.9% | 12.39 | 92.8% |
| | 2 | 130 | 1.2818 | 35.7 | 260 | 0.9238 | 252 | 176 | 77 | 1.1229 | 29.0% | 63.8% | 17.30 | 129.6% |
| | 3 | 130 | 1.2811 | 35.3 | 266 | 0.9232 | 258 | 178 | 79 | 1.1254 | 28.6% | 66.6% | 17.15 | 128.5% |
| | 4 | 125 | 1.2838 | 35.4 | 273 | 0.9229 | 260 | 182 | 80 | 1.1348 | 29.8% | 61.1% | 16.93 | 126.8% |
| | 5 | 124 | 1.2869 | 35.7 | 276 | 0.9224 | 262 | 181 | 82 | 1.1333 | 29.5% | 60.9% | 17.21 | 128.9% |
| | 6 | 125 | 1.2868 | 37 | 273 | 0.9248 | 259 | 181 | 78 | 1.1371 | 29.9% | 61.6% | 16.54 | 123.9% |

TABLE 13
Tannin Analysis for Multiple Replication Trial

| Sample | | Total | Insolubles | Non-Tannin | Tannin | Tannin | pH std | Purity |
|---|---|---|---|---|---|---|---|---|
| # | Sample ID | Solids (%) | (% as rec.) | (% as rec.) | (% as rec.) | (% dry wt) | units | % |
| 49 | Mixture 26.5% 100/200 (repeat of #22) Rep 1 | 24.71 | 0.09 | 10.84 | 13.78 | 55.77 | 3.48 | 55.97 |
| 22 | SuperReTan Mix 26.5% 100:200 Rep #1 | 24.71 | 0.09 | 9.27 | 15.35 | 62.12 | 3.48 | 62.35 |
| 23 | SuperReTan Mix 26.5% 100:200 Rep #2 | 26.38 | 1.18 | 10.38 | 14.82 | 56.18 | 3.51 | 58.81 |
| 24 | SuperReTan Mix 26.5% 100/200 Rep #3 | 26.74 | 0.12 | 10.43 | 15.43 | 57.70 | 3.49 | 59.67 |
| 39 | Mixture 27% 100/200 Rep 4 | 26.35 | 0.12 | 10.89 | 15.34 | 58.22 | 3.52 | 58.48 |
| 9 | SuperReTan Mix 25% 100/200 Rep #5 | 27.46 | 1.32 | 9.22 | 10.79 | 39.29 | 3.54 | 41.28 |
| 10 | SuperReTan Mix 25% 100/200 Rep # 6 | 26.27 | 1.06 | 11.13 | 11.12 | 42.33 | 3.51 | 44.15 |
| 6 | SuperReTan Mix 26.5% 150/200 Rep #1 | 22.51 | 0.09 | 9.32 | 13.11 | 58.24 | 3.46 | 58.43 |
| 7 | SuperReTan Mix 26.5% 150/200 Rep #2 | 23.25 | 0.18 | 9.36 | 13.71 | 58.97 | 3.44 | 59.43 |
| 8 | SuperReTan Mix 26.5% 150/200 Rep # 3 | 23.91 | 0.14 | 9.69 | 14.08 | 58.89 | 3.45 | 59.23 |
| 32 | Mixture 27% 150/200 Rep 4 | 23.45 | 0.05 | 10.03 | 13.37 | 57.01 | 3.46 | 57.14 |
| 47 | Mixture 25% 150/200 Rep 5 | 24.42 | 0.37 | 10.15 | 13.91 | 56.96 | 3.43 | 57.81 |
| 48 | Mixture 25% 150/200 Rep 6 | 24.93 | 0.01 | 10.48 | 14.45 | 57.96 | 3.81 | 57.96 |
| 27 | SuperReTan Mix 26.5% 200/200 Rep 1 | 20.65 | 0.44 | 7.87 | 12.34 | 59.76 | 3.45 | 61.06 |
| 28 | SuperReTan Mix 26.5% 200/200 Rep 2 | 21.43 | 0.52 | 8.59 | 12.32 | 57.49 | 3.41 | 58.92 |
| 29 | SuperReTan Mix 26.5% 200/200 Rep 3 | 22.09 | 0.44 | 8.37 | 13.28 | 60.12 | 3.41 | 61.34 |
| 34 | Mixture 27% 200/200 Rep 4 | 21.82 | 0.01 | 9.36 | 12.45 | 57.06 | 3.42 | 57.08 |
| 45 | Mixture 25% 200/200 Rep 5 | 22.42 | 0.11 | 9.51 | 12.81 | 57.14 | 3.38 | 57.39 |
| 46 | Mixture 25% 200/200 Rep 6 | 22.46 | 0.22 | 9.41 | 12.84 | 57.17 | 3.39 | 57.73 |
| 37 | 3 Bucket Mix 30% Jun. 9, 2000 100/20015″ | 36.03 | 0.47 | 13.12 | 22.44 | 62.28 | 3.46 | 63.1 |
| 12 | SuperReTan 3 jug mix 34% 100/200 Rep 2 | 35.81 | 0.62 | 11.72 | 23.46 | 65.51 | 3.41 | 66.69 |
| 13 | SuperReTan 3 jug mix 34% 100/200 Rep 3 | 36.61 | 0.59 | 10.82 | 25.21 | 68.86 | 3.38 | 69.96 |
| 40 | Mixture 34% 100/200 Rep 4 | 35.65 | 0.03 | 13.2 | 22.42 | 62.89 | 3.49 | 62.94 |
| 41 | Mixture 34% 100/200 Rep 5 | 36.04 | 0.45 | 12.91 | 22.68 | 62.93 | 3.43 | 63.73 |
| 42 | Mixture 34% 100/200 Rep 6 | 36.22 | 0.2 | 13.24 | 22.78 | 62.89 | 3.42 | 63.24 |
| 36 | 3 Bucket Mix Jun. 9, 2000 150/200 | 32.46 | 0.43 | 12.02 | 20.01 | 61.65 | 3.38 | 62.47 |
| 30 | SuperReTan 3 jug mix 34% 150/200 Rep 2 | 31.89 | 0.22 | 10.17 | 21.5 | 67.42 | 3.32 | 67.89 |
| 31 | SuperReTan 3 jug mix 34% 150/200 Rep 3 | 32.34 | 0.28 | 10.21 | 21.85 | 67.56 | 3.33 | 68.15 |
| 25 | SuperReTan Mix 34% 150/200 Rep #4 | 33.27 | 6.72 | 10.51 | 16.04 | 48.21 | 3.41 | 60.41 |
| 26 | SuperReTan Mix 34% 150/200 Rep #5 | 33.02 | 0.48 | 12.01 | 20.54 | 62.20 | 3.37 | 63.12 |
| 33 | Mixture 34% 150/200 Rep 6 | 32.44 | 0.62 | 11.82 | 20.01 | 61.68 | 3.38 | 62.85 |
| 38 | 3 Bucket Mix Jun. 9, 2000 | 23.91 | 0.14 | 9.69 | 14.08 | 58.89 | 3.45 | 59.23 |
| 14 | SuperReTan 3 jug mix 34% 200/200 2 | 31.38 | 1.93 | 9.64 | 20.01 | 63.77 | 3.31 | 67.91 |
| 15 | SuperReTan 3 jug mix 34% 200/200 Rep 3 | 28.97 | 0.29 | 9.39 | 19.29 | 66.59 | 3.31 | 67.26 |
| 43 | Mixture 34% 200/200 Rep 4 | 30.51 | 0.24 | 11.62 | 18.65 | 61.13 | 3.32 | 61.61 |
| 44 | Mixture 34% 200/200 Rep 5 | 30.41 | 0.12 | 11.76 | 18.52 | 60.90 | 3.32 | 61.16 |

TABLE 14
Statistical Analysis of Multiple Replication Trial -
Percent of Tannin Recovered (Using all 36 observations) -
Randomized complete block design

| Treatment | Blocks (IPA:ReTan Ratio) | | | Treatment Totals | |
|---|---|---|---|---|---|
| (% solids) | 100:200 | 150:200 | 200:200 | sum | sq-sum |
| 27% | 81.97 | 94.04 | 98.90 | 1643.45 | 152271.40 |
| | 87.25 | 92.99 | 95.92 | | |
| | 88.50 | 98.43 | 104.61 | | |
| | 91.48 | 93.97 | 98.09 | | |
| | 63.44 | 95.64 | 98.07 | | |
| | 63.13 | 98.68 | 98.33 | | |
| 34% | 87.25 | 89.19 | 69.43 | 1623.81 | 147380.83 |
| | 89.23 | 93.34 | 96.91 | | |
| | 88.66 | 95.03 | 96.07 | | |
| | 90.09 | 74.56 | 94.84 | | |
| | 93.50 | 93.80 | 96.41 | | |
| | 91.34 | 91.50 | 92.66 | | |
| Block sum | 1015.83 | 1111.18 | 1140.24 | 3267.26 | |
| Total sq-sum | 87177.7 | 103323.4 | 109151.05 | | 299652.22 |

| Source of variation | df | SS | MS | F calc |
|---|---|---|---|---|
| Blocks | 2.00 | 705.94 | 352.97 | 5.96 |
| Treatments | 1.00 | 10.71 | 10.71 | 0.18 |
| Interaction Error | 2.00 | 632.45 | 316.23 | |
| Within Error | 30.00 | 1776.48 | 59.22 | |
| Total | 35.00 | 3125.59 | | |

Differences in Treatment (% solids)

| | | | |
|---|---|---|---|
| F table (1,30 df) | FALSE | F calc > | lsd = NA |
| at 95% = 4.17 | | F table | |

F calc is not greater than F table at 95% confidence therefore
there is no significant difference due to Treatment (i.e. %
solids of starting ReTan)

| | | |
|---|---|---|
| Differences in | NA | are |
| Mean greater than | | significant |

Differences in Blocks (IPA:ReTan Ratio)

| F table (2,30 df) | TRUE | Fcalc > | lsd = 9.07 |
|---|---|---|---|
| at 95% = 3.32 | | F table | @95% |
| F calc is greater than F table at 95% confidence therefore | | | |
| there IS A significant difference due to Block Effect | | | |
| (i.e. Ratio of IPA:ReTan) | | | |
| Differences in | 9.07 | are | |
| Mean greater than | | significant | |

### Example 7

### Tannin Recovery From Dried/Powdered ReTan Material

It was considered important to determine if dried ReTan could be redissolved in water and then treated through isopropyl alcohol fractionation to recover active tannins. To determine if there was a measurable decrease in polyphenol recovery in this process as the powdered tannin aged, three classes of dried ReTan were used for this trial:

1) Recently produced powdered ReTan (1-4 months old),

2) ReTan that had been stored for 1-2 years, and

3) ReTan Samples that were approximately 4 years old

Materials from all three age classes were dissolved in warm water to generate ReTan liquor samples at approximately 25% and 30% solids content. The recently dried ReTan was completely soluble in warm water. The samples that had been stored longer times (1-2 and 4 years) gave small amounts of insoluble material, about 1.5% and 2.4%, respectively. Results and data of the isopropyl alcohol fractionation of powdered ReTan are given in Tables 15-22. Tannin analysis of the starting powdered ReTan is presented in Table 15, and a summary of Tables 17 through 22 is provided as Table 16.

TABLE 15
ReTan Analysis (Liquor and Powdered Starting Materials)

| | | Total Solids | Insolubles | Non-Tannin | Tannin wet | Tannin Dry | pH | Purity |
|---|---|---|---|---|---|---|---|---|
| Date | Material | % | % | % | % | % | STD | % |
| 05/04 | Liquor | 31.92 | 0.01 | 24.74 | 7.18 | 22.49 | 3.65 | 22.49 |
| 05/09 | Liquor | 32.71 | 0.01 | 24.94 | 7.77 | 23.75 | 3.64 | 23.75 |
| 05/17 | Liquor | 32.4 | 0.01 | 24.21 | 8.19 | 25.28 | 3.55 | 25.28 |
| 05/23 | Liquor | 33.01 | 0.55 | 23.54 | 8.92 | 27.02 | 3.51 | 27.48 |
| 05/30 | Liquor | 33.71 | 0.16 | 24.18 | 9.36 | 27.77 | 3.54 | 27.91 |
| Average | | 32.75 | 0.15 | 24.32 | 8.28 | 25.26 | 3.58 | 25.38 |
| Recent | Powder | 95.52 | 0 | 71.49 | 24.03 | 25.16 | 3.87 | 25.16 |
| 1-2 yr Old | Powder | 94.58 | 0 | 63.97 | 30.61 | 32.36 | 3.62 | 32.36 |
| Oldest | Powder | 93.22 | 0.87 | 67.53 | 24.82 | 26.63 | 3.91 | 26.91 |
| Average | | 94.44 | 0.29 | 67.66 | 26.49 | 28.05 | 3.80 | 28.14 |

TABLE 16
Powdered ReTan Recovery Summary

| ReTan Age | Solids | Mix Ratio | Tannin Recovery |
|---|---|---|---|
| New | 25% | 100:200 | 88% |
| New | 25% | 150:200 | 67% |
| New | 25% | 200:200 | 93% |
| New | 30% | 100:200 | 119% |
| New | 30% | 150:200 | 109% |
| New | 30% | 200:200 | 111% |
| 1-2 years | 25% | 100:200 | 116% |
| 1-2 years | 25% | 150:200 | 114% |
| 1-2 years | 25% | 200:200 | 119% |
| 1-2 years | 30% | 100:200 | 137% |
| 1-2 years | 30% | 150:200 | 141% |
| 1-2 years | 30% | 200:200 | 145% |
| Oldest | 25% | 100:200 | 89% |
| Oldest | 25% | 150:200 | 101% |
| Oldest | 25% | 200:200 | 105% |
| Oldest | 30% | 100:200 | 113% |
| Oldest | 30% | 150:200 | 116% |
| Oldest | 30% | 200:200 | 121% |

TABLE 17
Powdered ReTan, New Sample, 25.6% Solids Liquor Data
SuperReTan Fractionation of “Various Aged ReTan” from
E. H. Hall/Westfield Tanning Co.

| Newest ReTan | | |
|---|---|---|
| Initial Volume of ReTan = | 200 | ml |
| Initial Percent Solids = | 25.6% | % |
| Initial Total Solids = | 54.96 | gm |
| Initial Active Tannins | 24.03% | % |
| Initial Active Tannins | 13.2 | gm |

| | | | | Final |
|---|---|---|---|---|
| | Initial | Final | | Aqueous |
| IPA ReTan | Aqueous | Aqueous | % | Density |
| Ratio (ml:ml) | Volume (ml) | Volume (ml) | IPA | (gm/ml) |
| 100:200 | 122 | 105 | 13.9% | 1.22 |
| 150:200 | 110 | 95 | 13.6% | 1.24 |
| 200:200 | 102 | 90 | 11.8% | 1.25 |

| | Aqueous | Aqueous | | |
|---|---|---|---|---|
| IPA ReTan | Residual | Active* Tannin | Aqueous Tannin | |
| Ratio (ml:ml) | % solids | Content (%) | Recovered (gm) | |
| 100:200 | 27.9 | 7.07 | 2.57 | |
| 150:200 | 30.7 | 6.19 | 2.26 | |
| 200:200 | 31.6 | 19.23 | 7.10 | *** |

| | | | “Super- | |
|---|---|---|---|---|
| | “Top” Initial | Alcohol | ReTan” | Residual |
| IPA ReTan | Alcohol | Volume | Residual | Density |
| Ratio (ml:ml) | Volume (ml) | Recovered (ml) | Volume (ml) | (gm/ml) |
| 100:200 | 177 | 83 | 91 | 1.11 |
| 150:200 | 240 | 135 | 104 | 1.09 |
| 200:200 | 295 | 182 | 112 | 1.08 |

| IPA ReTan | Residual | Active* Tannin | Alcohol Tannin |
|---|---|---|---|
| Ratio (ml:ml) | % solids | Content (%) | Recovered (gm) |
| 100:200 | 22.2 | 50.77 | 11.64 |
| 150:200 | 19.6 | 39.48 | 8.86 |
| 200:200 | 18.6 | 54.10 | 12.28 |

| | Alcohol | Total Percent | EFFICIENCY |
|---|---|---|---|
| | Percent | Tannin Recovered | Tannin Recovered |
| | Tannin | Alcohol + | Alcohol % of |
| IPA ReTan | Recovered | Aqueous | total |
| Ratio (ml:ml) | (% of orig.) | (% of orig.) | (% of recov.) |
| 100:200 | 88.1% | 107.6% | 81.9% |
| 150:200 | 67.1% | 84.2% | 79.7% |
| 200:200 | 93.0% | 146.7% | 63.4% |

TABLE 18
Powdered ReTan, New Sample, 30.8% Solids Liquor Data
SuperReTan Fractionation of “Various Aged ReTan”
from E. H. Hall/Westfield Tanning Co.

| Newest ReTan | | |
|---|---|---|
| Initial Volume of ReTan = | 200 | ml |
| Initial Percent Solids = | 30.8% | % |
| Initial Total Solids = | 65.96 | gm |
| Initial Active Tannins | 24.03% | % |
| Initial Active Tannins | 15.9 | gm |

| | | | | Final |
|---|---|---|---|---|
| | Initial | Final | | Aqueous |
| IPA ReTan | Aqueous | Aqueous | % | Density |
| Ratio (ml:ml) | Volume (ml) | Volume (ml) | IPA | (gm/ml) |
| 100:200 | 143 | 125 | 12.6% | 1.25 |
| 150:200 | 131 | 114 | 13.0% | 1.26 |
| 200:200 | 121 | 104 | 14.0% | 1.27 |

| | Aqueous | Aqueous | | |
|---|---|---|---|---|
| IPA ReTan | Residual | Active* Tannin | Aqueous Tannin | |
| Ratio (ml:ml) | % solids | Content (%) | Recovered (gm) | |
| 100:200 | 31.4 | 7.85 | 3.91 | |
| 150:200 | 33.4 | 7.19 | 3.49 | |
| 200:200 | 35 | 5.74 | 2.65 | *** |

| | | | “Super- | |
|---|---|---|---|---|
| | “Top” Initial | Alcohol | ReTan” | Residual |
| IPA ReTan | Alcohol | Volume | Residual | Density |
| Ratio (ml:ml) | Volume (ml) | Recovered (ml) | Volume (ml) | (gm/ml) |
| 100:200 | 156 | 83 | 79 | 1.13 |
| 150:200 | 216 | 131 | 79 | 1.12 |
| 200:200 | 276 | 182 | 90 | 1.11 |

| IPA ReTan | Residual | Active* Tannin | Alcohol Tannin |
|---|---|---|---|
| Ratio (ml:ml) | % solids | Content (%) | Recovered (gm) |
| 100:200 | 28.2 | 61.31 | 15.66 |
| 150:200 | 26.1 | 62.19 | 14.45 |
| 200:200 | 24.3 | 60.32 | 14.60 |

| | Alcohol | Total Percent | EFFICIENCY |
|---|---|---|---|
| | Percent | Tannin Recovered | Tannin Recovered |
| | Tannin | Alcohol + | Alcohol % of |
| IPA ReTan | Recovered | Aqueous | total |
| Ratio (ml:ml) | (% of orig.) | (% of orig.) | (% of recov.) |
| 100:200 | 118.6% | 148.1% | 80.0% |
| 150:200 | 109.4% | 135.8% | 80.5% |
| 200:200 | 110.5% | 130.6% | 84.6% |

TABLE 19
Powdered ReTan, 1-2 Year Sample, 25.6% Solids Liquor
Data SuperReTan Fractionation of “Various Aged ReTan”
from E. H. Hall/Westfield Tanning Co.

| 1-2 Year old ReTan | | |
|---|---|---|
| Initial Volume of ReTan = | 200 | ml |
| Initial Percent Solids = | 24.5% | % |
| Initial Total Solids = | 55.50 | gm |
| Initial Active Tannins | 30.61% | % |
| Initial Active Tannins | 17.0 | gm |

| | | | | Final |
|---|---|---|---|---|
| | Initial | Final | | Aqueous |
| IPA ReTan | Aqueous | Aqueous | % | Density |
| Ratio (ml:ml) | Volume (ml) | Volume (ml) | IPA | (gm/ml) |
| 100:200 | 75 | 60 | 20.0% | 1.21 |
| 150:200 | 89 | 74 | 16.9% | 1.24 |
| 200:200 | 80 | 69 | 13.8% | 1.26 |

| | Aqueous | Aqueous | | |
|---|---|---|---|---|
| IPA ReTan | Residual | Active* Tannin | Aqueous Tannin | |
| Ratio (ml:ml) | % solids | Content (%) | Recovered (gm) | |
| 100:200 | 27.3 | 9.06 | 1.84 | |
| 150:200 | 29.7 | 6.02 | 1.68 | |
| 200:200 | 31.5 | 1.76 | 0.49 | *** |

| | | | “Super- | |
|---|---|---|---|---|
| | “Top” Initial | Alcohol | ReTan” | Residual |
| IPA ReTan | Alcohol | Volume | Residual | Density |
| Ratio (ml:ml) | Volume (ml) | Recovered (ml) | Volume (ml) | (gm/ml) |
| 100:200 | 222 | 85 | 134 | 1.12 |
| 150:200 | 257 | 134 | 121 | 1.1 |
| 200:200 | 316 | 184 | 127 | 1.1 |

| IPA ReTan | Residual | Active* Tannin | Alcohol Tannin |
|---|---|---|---|
| Ratio (ml:ml) | % solids | Content (%) | Recovered (gm) |
| 100:200 | 23.0 | 43.27 | 15.38 |
| 150:200 | 20.6 | 55.28 | 15.12 |
| 200:200 | 19.1 | 57.46 | 15.66 |

| | Alcohol | Total Percent | EFFICIENCY |
|---|---|---|---|
| | Percent | Tannin Recovered | Tannin Recovered |
| | Tannin | Alcohol + | Alcohol % of |
| IPA ReTan | Recovered | Aqueous | total |
| Ratio (ml:ml) | (% of orig.) | (% of orig.) | (% of recov.) |
| 100:200 | 116.5% | 130.4% | 89.3% |
| 150:200 | 114.5% | 127.2% | 90.0% |
| 200:200 | 118.6% | 122.3% | 97.0% |

TABLE 20
Powdered ReTan, 1-2 Year Sample, 30.8% Solids Liquor
Data SuperReTan Fractionation of “Various Aged ReTan”
from E. H. Hall/Westfield Tanning Co.

| 1-2 Year old ReTan | | |
|---|---|---|
| Initial Volume of ReTan = | 200 | ml |
| Initial Percent Solids = | 30.1% | % |
| Initial Total Solids = | 66.62 | gm |
| Initial Active Tannins | 30.61% | % |
| Initial Active Tannins | 20.4 | gm |

| | | | | Final |
|---|---|---|---|---|
| | Initial | Final | | Aqueous |
| IPA ReTan | Aqueous | Aqueous | % | Density |
| Ratio (ml:ml) | Volume (ml) | Volume (ml) | IPA | (gm/ml) |
| 100:200 | 130 | 112 | 13.8% | 1.22 |
| 150:200 | 114 | 99 | 13.2% | 1.24 |
| 200:200 | 103 | 89 | 13.6% | 1.23 |

| | Aqueous | Aqueous | | |
|---|---|---|---|---|
| IPA ReTan | Residual | Active* Tannin | Aqueous Tannin | |
| Ratio (ml:ml) | % solids | Content (%) | Recovered (gm) | |
| 100:200 | 30.2 | 9.55 | 3.95 | |
| 150:200 | 31.7 | 8.00 | 3.17 | |
| 200:200 | 33.7 | 5.91 | 2.20 | *** |

| | | | “Super- | |
|---|---|---|---|---|
| | “Top” Initial | Alcohol | ReTan” | Residual |
| IPA ReTan | Alcohol | Volume | Residual | Density |
| Ratio (ml:ml) | Volume (ml) | Recovered (ml) | Volume (ml) | (gm/ml) |
| 100:200 | 167 | 80 | 84 | 1.14 |
| 150:200 | 233 | 133 | 97 | 1.13 |
| 200:200 | 294 | 184 | 106 | 1.12 |

| IPA ReTan | Residual | Active* Tannin | Alcohol Tannin |
|---|---|---|---|
| Ratio (ml:ml) | % solids | Content (%) | Recovered (gm) |
| 100:200 | 30.0 | 62.11 | 18.05 |
| 150:200 | 27.4 | 61.59 | 18.64 |
| 200:200 | 25.6 | 63.27 | 19.14 |

| | Alcohol | Total Percent | EFFICIENCY |
|---|---|---|---|
| | Percent | Tannin Recovered | Tannin Recovered |
| | Tannin | Alcohol + | Alcohol % of |
| IPA ReTan | Recovered | Aqueous | total |
| Ratio (ml:ml) | (% of orig.) | (% of orig.) | (% of recov.) |
| 100:200 | 136.7% | 166.6% | 82.1% |
| 150:200 | 141.2% | 165.2% | 85.5% |
| 200:200 | 144.9% | 161.6% | 89.7% |

TABLE 21
Powdered ReTan, Old Sample, 25.4% Solids Liquor Data
SuperReTan Fractionation of “Various Aged ReTan”
from E. H. Hall/Westfield Tanning Co.

| Oldest ReTan | | |
|---|---|---|
| Initial Volume of ReTan = | 200 | ml |
| Initial Percent Solids = | 25.4% | % |
| Initial Total Solids = | 56.32 | gm= |
| Initial Active Tannins | 24.82% | % |
| Initial Active Tannins | 14.0 | gm |

| | | | | Final |
|---|---|---|---|---|
| | Initial | Final | | Aqueous |
| IPA ReTan | Aqueous | Aqueous | % | Density |
| Ratio (ml:ml) | Volume (ml) | Volume (ml) | IPA | (gm/ml) |
| 100:200 | 121 | 99 | 18.2% | 1.20 |
| 150:200 | 106 | 89 | 16.0% | 1.23 |
| 200:200 | 88 | 76 | 13.6% | 1.25 |

| | Aqueous | Aqueous | | |
|---|---|---|---|---|
| IPA ReTan | Residual | Active* Tannin | Aqueous Tannin | |
| Ratio (ml:ml) | % solids | Content (%) | Recovered (gm) | |
| 100:200 | 27.3 | 8.31 | 2.71 | |
| 150:200 | 29.2 | 5.60 | 1.83 | |
| 200:200 | 31.4 | 4.59 | 1.37 | *** |

| | | | “Super- | |
|---|---|---|---|---|
| | “Top” Initial | Alcohol | ReTan” | Residual |
| IPA ReTan | Alcohol | Volume | Residual | Density |
| Ratio (ml:ml) | Volume (ml) | Recovered (ml) | Volume (ml) | (gm/ml) |
| 100:200 | 176 | 78 | 95 | 1.12 |
| 150:200 | 240 | 133 | 105 | 1.11 |
| 200:200 | 307 | 183 | 122 | 1.10 |

| IPA ReTan | Residual | Active* Tannin | Alcohol Tannin |
|---|---|---|---|
| Ratio (ml:ml) | % solids | Content (%) | Recovered (gm) |
| 100:200 | 23.2 | 47.34 | 11.73 |
| 150:200 | 21.1 | 53.10 | 13.37 |
| 200:200 | 20.0 | 50.91 | 13.88 |

| | Alcohol | Total Percent | EFFICIENCY |
|---|---|---|---|
| | Percent | Tannin Recovered | Tannin Recovered |
| | Tannin | Alcohol + | Alcohol % of |
| IPA ReTan | Recovered | Aqueous | total |
| Ratio (ml:ml) | (% of orig.) | (% of orig.) | (% of recov.) |
| 100:200 | 88.8% | 109.3% | 81.2% |
| 150:200 | 101.2% | 115.1% | 88.0% |
| 200:200 | 105.1% | 115.4% | 91.0% |

TABLE 22
Powdered ReTan, Old Sample, 30.8% Solids Liquor Data
SuperReTan Fractionation of “Various Aged ReTan”
from E. H. Hall/Westfield Tanning Co.

| Oldest ReTan | | |
|---|---|---|
| Initial Volume of ReTan = | 200 | ml |
| Initial Percent Solids = | 30.1% | % |
| Initial Total Solids = | 67.58 | gm |
| Initial Active Tannins | 24.82% | % |
| Initial Active Tannins | 16.8 | gm |

| | | | | Final |
|---|---|---|---|---|
| | Initial | Final | | Aqueous |
| IPA ReTan | Aqueous | Aqueous | % | Density |
| Ratio (ml:ml) | Volume (ml) | Volume (ml) | IPA | (gm/ml) |
| 100:200 | 133 | 115 | 13.5% | 1.23 |
| 150:200 | 126 | 109 | 13.5% | 1.25 |
| 200:200 | 105 | 91 | 13.3% | 1.26 |

| | Aqueous | Aqueous | | |
|---|---|---|---|---|
| IPA ReTan | Residual | Active* Tannin | Aqueous Tannin | |
| Ratio (ml:ml) | % solids | Content (%) | Recovered (gm) | |
| 100:200 | 30.9 | 8.05 | 3.51 | |
| 150:200 | 32.5 | 6.07 | 2.70 | |
| 200:200 | 34.1 | 6.42 | 2.56 | *** |

| | | | “Super- | |
|---|---|---|---|---|
| | “Top” Initial | Alcohol | ReTan” | Residual |
| IPA ReTan | Alcohol | Volume | Residual | Density |
| Ratio (ml:ml) | Volume (ml) | Recovered (ml) | Volume (ml) | (gm/ml) |
| 100:200 | 164 | 83 | 79 | 1.13 |
| 150:200 | 222 | 132 | 88 | 1.12 |
| 200:200 | 288 | 180 | 102 | 1.12 |

| IPA ReTan | Residual | Active* Tannin | Alcohol Tannin |
|---|---|---|---|
| Ratio (ml:ml) | % solids | Content (%) | Recovered (gm) |
| 100:200 | 27.8 | 59.51 | 14.88 |
| 150:200 | 25.4 | 60.02 | 15.30 |
| 200:200 | 24.5 | 56.18 | 15.94 |

| | Alcohol | Total Percent | EFFICIENCY |
|---|---|---|---|
| | Percent | Tannin Recovered | Tannin Recovered |
| | Tannin | Alcohol + | Alcohol % of |
| IPA ReTan | Recovered | Aqueous | total |
| Ratio (ml:ml) | (% of orig.) | (% of orig.) | (% of recov.) |
| 100:200 | 112.7% | 139.2% | 80.9% |
| 150:200 | 115.8% | 136.2% | 85.0% |
| 200:200 | 120.7% | 140.0% | 86.2% |

No production difficulties were encountered with the reconstituted liquor from powdered ReTan. In fact, the reconstituted liquor performed as well as or better that the previously tested materials in terms of higher tannin recovery efficiencies. It is unclear why there consistently were recovery efficiencies in excess of 100%. It is thought that perhaps the hide powder analysis for active tannin content for the dried ReTan were consistently under represented due to incomplete solubilization of the initial dry powder. Additionally, the use of the alcohol in this trial may have reconstituted additional tannins from water insoluble materials. It is clear from the results of this trail that the isopropyl alcohol fractionation method can be used to recover significant amounts of tannins from dried ReTan for reuse in the leather manufacturing process.

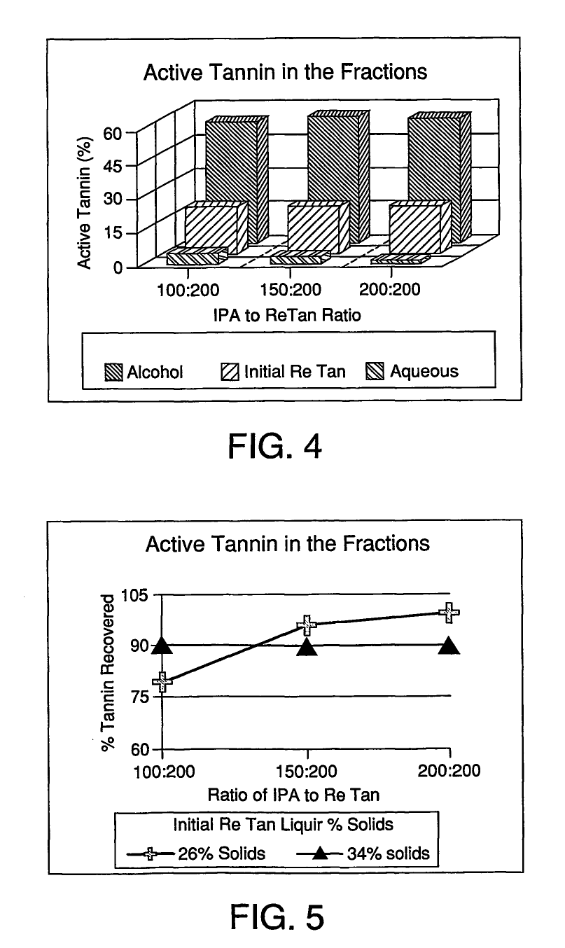

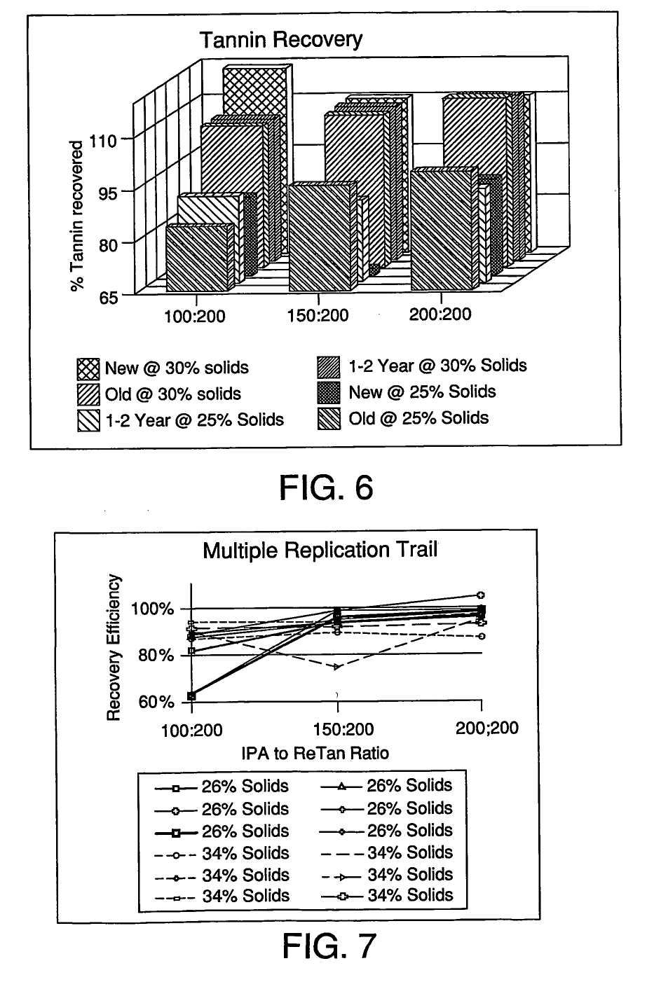

FIG. 4 illustrates the effectiveness of the fractionation process in separating the active tannin contained in the initial ReTan into the alcohol phase, and that very little active tannin is lost to the aqueous phase. FIGS. 5, 6, & 7, are graphs summarizing the multiple replication fractionation trials and powdered ReTan work. It is clearly seen from FIG. 5 that the recovery of active tannins from higher percent solids liquor is not reduced at the lower ratio of alcohol to ReTan.

### Example 8

### Two Industrial Leather Tanning Trials

The primary objectives of the first industrial leather tanning trial were four fold: 1) to ensure that the fractionation recovery method would “scale up” from bench top to the production level needed at a tannery; 2) to evaluate the operational aspects and constraints of the more economical off-the-shelf, equipment rather than custom engineered units; 3) to explore the unique physical processing aspects relevant to the fractions (adhesion, high solids, temperature dependence etc . . . ); 4) to produce a significant volume of SuperReTan material needed for subsequent leather production trials.

Approximately 80 gallons of ReTan liquor at 30% solids was brought in two transport drums to the test facility, which had arranged to have 55 gallons of 100% isopropyl alcohol on hand. After manually agitating the ReTan by rolling the drums back and forth across the lab floor, the alcohol and the ReTan were added at a 1:2 vol:vol mixture into a stainless steel reaction kettle. The reaction kettle was equipped with a strain gauge (lbs.), so material volumes were back calculated using data available on specific gravity and density to determine volumes. The kettle was also equipped with an electric stirrer which was augmented by manual agitation for approximately 20 minutes. The mix was allowed to settle for 30 minutes and then decanted from the bottom, with the boundary between the two fractions determined by visual color change. At this time the bottom “aqueous” fraction was not investigated. The first batch of “top fraction” material was processed in a countercurrent falling film evaporator operated at 150 mm Hg of reduced pressure resulting in a maximum processing temperature of 135° F. Rate of flow through the evaporator was regulated with the feed pump to ensure the proper residence time for alcohol stripping. The system operated efficiently, but a distinct alcohol odor was present in the produced SuperReTan and a phase separation was visible in the collection vessel as an extremely thin surface layer of near black liquid. The second batch of “top fraction” material was run in the same evaporator at basically the same conditions, but at a higher reduced pressure of 250 mm Hg and a slower flow rate to increase residence time. The resulting SuperReTan generated had no phase separation visible in the collection vessel and only a hint of alcohol odor that was difficult to isolate from the rest of the trial facility. Samples of both SuperReTan were used in the leather production trials with very similar results.

Second Trial—Laboratory tests after the first industrial trial revealed that a significant volume of alcohol was present in the “bottom fraction.” It was initially believed that due to the distinct phase separation, nearly all the alcohol was in the top fraction. After distilling samples in our researcher's lab and using temperature and deduction, it was determined that the bottom fraction contained between 5.5% and 9% alcohol. It was quickly concluded that economic and environmental concerns would not permit this amount of alcohol waste per recovery cycle. Therefore, the inventor investigated a forced circulation (fc) evaporator for stripping and recovering the alcohol from the bottom fraction. ReTan and alcohol were mixed, agitated, and decanted into two separate fractions. An approximate 50 gallon sample each of “tops” and “bottoms” was brought to the vendors test facility. The forced circulation evaporator processed the bottom (aqueous) fraction with no apparent difficulties and samples were taken before and after for lab analysis. The bottom fraction contains no material that is temperature sensitive and the test was done at atmospheric pressure. Residence time in the evaporator was again controlled by regulating the material feed pump, and evaporator temperature was controlled by the steam feed. Results of the alcohol removal from 7%-10% initially to below 0.5% afterwards are presented below in Table 23.

TABLE 23
Isopropyl Alcohol Recovery Efficiency

| Lab | Our | Initial | Material | Percent | | Solids |
|---|---|---|---|---|---|---|
| ID# | ID | Fraction | Type | IPA (%) | Viscosity | (mg/l) |
| 112 | 1F Bottom | Aqueous | Feed | 10.10 | | 404.332 |
| 114 | 2F Bottom | Aqueous | Feed | 7.10 | | 446.696 |
| 118 | 4P Bottom | Aqueous | Product | 0.44 | 3.90 | 455.411 |
| 120 | 6P Bottom | Aqueous | Product | 0.38 | 4.63 | 543.415 |
| 121 | 7P Bottom | Aqueous | Product | 0.36 | 4.81 | 509.571 |
| 122 | 8P Bottom | Aqueous | Product | 0.35 | 4.82 | 514.307 |
| 113 | 1F Top | Alcohol | Feed | 57.80 | | 149.432 |
| 115 | 2F Top | Alcohol | Feed | 55.10 | | 149.650 |
| 2077 | 3P Top | Alcohol | Product | 17.90 | 6.79 | |
| 2078 | 4P Top | Alcohol | Product | 17.20 | 10.25 | |

Feed = Initial Material
Product = Residual material after evaporation

The countercurrent falling film evaporator operated at 250 mm Hg of reduced pressure produced a SuperReTan residual product that successfully made leather in Westfield's LIRITAN process. It is unknown what the exact alcohol recovery efficiency is of this evaporator, but it is judged that under the appropriate conditions (vacuum, and residence time) a less than 0.5% loss of isopropyl alcohol can be achieved. The forced circulation evaporator was found to remove isopropyl alcohol to less than 0.5% from the bottom fraction, which we have established as a minimum operating requirement based on economics (replacement cost) and air quality concerns (VOC emissions).

### Example 9

### Sulfitation and Fractionation of Quebracho Tannin

The success found in the above examples stimulated the question of whether or not it might be possible to upgrade commercial quebracho tannin to produce a tannin with improved leather making properties using this fractionation process. It seemed probable that a quebracho tannin that penetrated faster and resulted in improved leather properties such as strength and particularly color could be obtained by fractionation. To promote phase separation of sulphited quebracho tannins, the inventor used the aqueous phase containing phosphate salts obtained from alcohol fractionation of ReTan.

Sulfonation is used in the tanning industry to decrease the amount of non-solubles in tannin extract, which increases the tannin content. Sulfoantaion works because some tannin (a small percent, typically 2 to 5%) are not soluble in water. Typically for Quebracho extract, the sulfonation process is to add 4 to 8% bisulfite and cook at 205 degrees for 24 to 36 hours or until clear. Clarity is tested by adding 10 ml of the quebracho solution into 90 ml of deionized water. No particles should settle out. The resulting mixture should be a reddish color which is relatively transparent.

In this trial, Quebracho tannin (400 g) was heated with sodium metabisulfite (32 g) for 21 or 19 hours at 90 or 97° C. (194-206° F.). The lower temperature treatment (21 hours at 90° C.) left residual solids which were separated by filtration through glass wool. The higher temperature samples (19 hours at 97° C.) contained no solids and were used without filtering. To the hot sulfited samples was added 645 m L of aqueous phosphate salts previously recovered from the fractionation of ReTan. This caused some precipitation to occur immediately. The solubles were decanted from the very viscous material which had precipitated and which solidified upon cooling. The yield of this insoluble material averaged 81 g.

To the soluble sulfited tannin solution (1300 mL) was added 1000 mL of isopropyl alcohol (recovered azeotrope of 88% IPA and 12% water) in a separatory funnel. Upon standing layers separated forming a clear but dark brown upper layer and a cloudy brown lower layer. Separation of the layers gave on average 830 mL of the lower aqueous layer and 1915 mL of the upper organic layer. Removal of the alcohol under reduced pressure yielded 145 mL of isopropyl alcohol from the lower aqueous layer and 845 mL from the upper organic layer. Thus, one obtained about 1035 mL of aqueous, sulfite fractionated quebracho tannin solution. This product is novel as compared to known virgin quebracho extracts.

TABLE 24
EXTRACT ANALYSIS
Product: Fractional Sulfited Quebracho

| | Amount: |
|---|---|
| Sample Size (g): | 2560 |
| Moisture Content: | 72.46 |
| Total Solids: | 27.54 |
| Soluble Solids: | 27.22 |
| Insoluble Solids: | 0.32 |
| Non-Tannins: | 9.52 |
| Tannin Content: | 17.70 |
| pH: | 3.33 |
| Purity: | 65.03 |
| Specific Gravity: | 1.104 |

### Example 10

### ReTan Fractionation with 1-Propanol (n-Propyl Alcohol)

Although isopropyl alcohol gave excellent phase separations, the use of other alcohols might be competitive. Therefore, we examined the possibility of using 1-propanol (n-propyl alcohol). ReTan (30% solids) obtained from Westfield Tanning Company was heated to −70° C. to dissolve precipitated materials. One liter of this was then added to 1 L of 1-propanol in a separatory funnel. After shaking the funnel thoroughly the material was allowed to stand overnight. The next morning there was no obvious separation of layers but a check of densities of the upper and lower portions of the material in the funnel indicated that two layers did indeed exist (both layers were very dark and of the same color). The layers were separated by checking the densities every 100 mL and yielded 660 mL (34%) of the lower aqueous fraction and 1280 mL (66%) of the upper alcoholic fraction.

The alcohol was removed from the lower aqueous phase on a rotary evaporator and yielded 70 mL and left 580 mL of aqueous solution which should contain primarily the non-tannins (density=1.273 ghml; solids content=35.9%). [Note: 1-Propanol and water form a minimum boiling azeotrope which boils at 88° C. and consists of 78% 1-propanol and 28% water.] Similar treatment of the upper phase yielded 1210 mL of alcohol. Before the alcohol was completely removed the residue in the flask was becoming very viscous so 200 mL of water was added to the flask. After removal of the alcohol this aqueous residue of “alcohol solubles” amounted to 275 mL (density=1.098 glmL; solids content=27.4%).

Whereas it is possible to obtain phase separation using 1-propanol, the yield of recovered tannin (see Table 24) was only 23.2% and 74.2% of the starting material was in the aqueous phase. These results are far below those obtained with isopropyl alcohol.

### Example 11

### Product Recovery System Parameters and Analysis

The alcohol fractionation process can benefit both chrome and vegetable leather American tanneries, since chrome tanners can use the recovered super Retan to replace virgin tannins in the chrome tanning liquors. Using the optimum operating conditions established in the previous examples herein, an engineering analysis and economic feasibility task was performed to determine appropriate apparatus for the tannin recovery methods, as well as to estimate the costs of such a system. It was determined that either a distillation or an evaporative system would be needed to recover the significant volumes of liquids involved in the vegetable tanning process and the tannins recovery method.

Separate systems should preferably be used to process the alcohol and aqueous fractions due to several considerations and goals: 1) the materials have different physical properties (% solids, specific gravity, viscosity, and alcohol content); 2) the materials have different processing tolerances—the alcohol fraction cannot be heated above 170° F. or the tannins in the resulting SuperReTan would be oxidized and be rendered unsuitable for leather production (recovery needs to be done under reduced pressure conditions); 3) risks of operator error need to be well-controlled; 4) risk of contamination of SuperReTan during any recovery stream change need to be well-controlled; and; 5) recovery equipment settings should preferably not need to be changed between fractions.

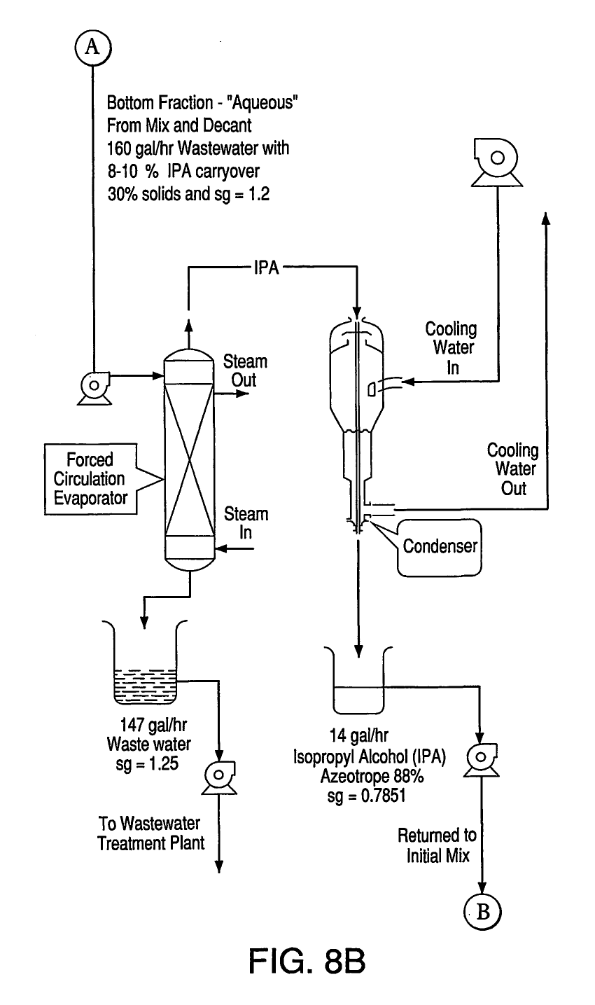

In meeting these goals, distillation equipment was found to be consistently and significantly more expensive than evaporative equipment. However, use of distillation and any other means of removing and recovering alcohol and water, and which is known to those skilled in the art, is within the scope of the inventive concept herein. Such means include, but are not limited to, multiple effect falling film, fixed film, wiped film, rising film and forced circulation evaporators. FIGS. 8A & 9B illustrate a conceptual process flow diagram developed as a result of this equipment sizing. The disclosed recovery system was designed with the capacity to process all of the evaporated liquor currently produced from a tannery operating five days per week, 12 hours per day. It was felt that the extra 12 hours per day could be used to process the powdered ReTan into SuperReTan.

The amount of SuperReTan produced in this conceptual pilot facility is based on data established during Phase I of 225 gal/hr of ReTan liquor starting at 34% solids and a sg of 1.2295. This liquor is mixed with 112.5 gal/hr of the azeotrope (88% alcohol and 12% water) of isopropyl alcohol resulting in the anticipated production after alcohol recovery of 77.7 gal/hr of SuperReTan at 36.2% solids and a sg of 1.172. See FIGS. 8A & 8B for process flow diagrams and expected hourly material flows and anticipated specific gravities and percent solids of the six liquors (initial ReTan, IPA, Top Fraction, Bottom Fraction, SuperReTan, and Bottom fraction phosphate sludge residual).

TABLE 25
Elemental Analysis of Alcohol and Aqueous Fractions (mg/kg)

| Ratio | Alcohol | Aqueous | Ratio | Alcohol | Aqueous |
|---|---|---|---|---|---|
| pH | | | Total | | |
| (std) | | | Nitrogen | | |
| 100:200 | 2.78 | 3.12 | 100:200 | 5,845 | 6,035 |
| 150:200 | 2.70 | 3.12 | 150:200 | 6,425 | 6,070 |
| 200:200 | 2.57 | 3.18 | 200:200 | 5,715 | 5,875 |
| | 2.68 | 3.14 | | 5,995 | 5,993 |
| Phosphate | * | | Potash | | |
| (P2O5) | | | (K2O) | | |
| 100:200 | 44,995 | 231,630 | 100:200 | 2,185 | 8,175 |
| 150:200 | 43,640 | 243,645 | 150:200 | 2,100 | 8,625 |
| 200:200 | 39,930 | 247,120 | 200:200 | 1,990 | 8,655 |
| | 42,855 | 240,798 | | 2,092 | 8,485 |
| Total | * | | | | |
| Organic | | | Total | | |
| Carbon | | | Calcium | | |
| 100:200 | 470,800 | 127,100 | 100:200 | 985 | 8,705 |
| 150:200 | 469,700 | 112,000 | 150:200 | 2,085 | 8,590 |
| 200:200 | 490,200 | 118,400 | 200:200 | 585 | 9,225 |
| | 476,900 | 119,167 | | 1,218 | 8,840 |
| Total | * | | Total | * | |
| Magnesium | | | Sulfur | | |
| 100:200 | 285 | 2,725 | 100:200 | 22,825 | 54,810 |
| 150:200 | 275 | 2,890 | 150:200 | 23,190 | 57,335 |
| 200:200 | 225 | 2,885 | 200:200 | 21,400 | 56,200 |
| | 262 | 2,833 | | 22,472 | 56,115 |
| Total | | | Total | | |
| Copper | | | Zinc | | |
| 100:200 | 5 | 5 | 100:200 | 10 | 30 |
| 150:200 | 5 | 5 | 150:200 | 10 | 25 |
| 200:200 | 5 | 5 | 200:200 | 10 | 20 |
| | 5 | 5 | | 10 | 25 |
| Total | | | Total | | |
| Manganese | | | Iron | | |
| 100:200 | 5 | 30 | 100:200 | 115 | 250 |
| 150:200 | 5 | 30 | 150:200 | 110 | 245 |
| 200:200 | 0 | 30 | 200:200 | 95 | 240 |
| | 3 | 30 | | 107 | 245 |
| Total | * | | Total | * | |
| Sodium | | | Aluminum | | |
| 100:200 | 38,805 | 136,405 | 100:200 | 0 | 660 |
| 150:200 | 37,445 | 143,590 | 150:200 | 5 | 625 |
| 200:200 | 36,625 | 141,805 | 200:200 | 0 | 615 |
| | 37,625 | 140,600 | | 2 | 633 |

Elemental Analysis Summary

| | Alcohol | Aqueous | |
|---|---|---|---|
| Parameter | Fraction | Fraction | Difference |
| Total Nitrogen | 5,995 | 5,993 | 0% |
| Phosphate (P2O5) | 42,855 | 240,798 | −462% |
| Potash (K2O) | 2,092 | 8,485 | −306% |
| Total Orgnic Carbon | 476,900 | 119,167 | 75% |
| Total Calcium | 1,218 | 8,840 | −626% |
| Total Magnesium | 262 | 2,833 | −983% |
| Total Sulfur | 22,472 | 56,115 | −150% |
| Total Copper | 5 | 5 | 0% |
| Total Zinc | 10 | 25 | −150% |
| Total Manganese | 3 | 30 | −800% |
| Total Iron | 107 | 245 | −130% |
| Total Sodium | 37,625 | 140,600 | −274% |
| Total Aluminum | 2 | 633 | −37900% |

The economic and operation evaluation of the alcohol fractionation and tannin recovery system indicate that this would be an easy system to integrate into a LIRATAN production facility, and that it holds great economic potential for tanneries that use plant polyphenols. The invention described herein is the first of its kind tannins recovery and recycling and re-use method. The method works effectively to separate the non-tannins from the tannins, as shown by data in Table 25 by the demonstrated difference in elemental concentration between the alcohol and aqueous fractions. This elemental data clearly shows the separation of tannins into the alcohol phase, as indicated by organic carbon at 48% of the alcohol fraction solids, versus 19% of the aqueous fraction solids. Additionally the significant removal of the impurities into the aqueous phase is seen by phosphate and sodium composing only 4.2% and 3.7% of alcohol fraction solids versus 24% and 14% of the aqueous fraction solids, respectively.

I claim:

1. A method of recovering plant polyphenols from spent vegetable tanning liquor comprising:
a. Providing spent vegetable tanning liquor;
b. Adding an alcohol to said spent tanning liquor to form a mixture;
C. Agitating said mixture;
d. Allowing said mixture to settle to form an alcohol fraction and an aqueous fraction;
e. Separating said alcohol fraction from said aqueous fraction; and,
f. Removing said alcohol from said alcohol fraction to form a residue containing plant polyphenols.

2. The method of claim 1, further comprising the step of adding said residue containing plant polyphenols to virgin tanning liquor to form an improved tanning liquor.

3. The method of claim 1, further comprising the step of recovering and drying said aqueous fraction to produce a soil fertilizer and pH adjustment product.

4. The method of claim 1, wherein said spent tanning liquor provided has solids in the range of 15% to 40% by weight.

5. The method of claim 1, wherein said spent tanning liquor provided has solids in the range of 25% to 35% by weight.

6. The method of claim 1, wherein said alcohol is selected from the group consisting of: isopropyl alcohol, n-propyl alcohol, n-butyl alcohol, sec-butyl alcohol, isobutyl alcohol, and tert-butyl alcohol.

7. A residue produced by the method of claim 1, claim 2, claim 3, claim 4, claim 5, or claim 6.

8. The soil fertilizer and pH adjustment product produced by the method of claim 3.

9. The improved tanning liquor produced by the method of claim 2.

10. A improved method of tanning leather comprising the steps of:
a. providing spent vegetable tanning liquor;
b. adding an alcohol to said spent tanning liquor to form a mixture;
c. agitating said mixture;
d. allowing said mixture to settle to form an alcohol fraction and an aqueous fraction;
e. separating said alcohol fraction from said aqueous fraction; and,
f. removing said alcohol from said alcohol fraction to form a residue containing plant polyphenols;
g. adding said residue containing plant polyphenols to virgin tanning liquor to form an improved tanning liquor; and,
h. exposing animal hides to said improved tanning liquor for a time sufficient to tan said hides.

11. The method of claim 10, wherein the spent tanning liquor provided has solids in the range of 15% to 40%.

12. The method of claim 10, wherein the spent tanning liquor provided has solids in the range of 25% to 35%.

13. The method of claim 10, wherein the alcohol is selected from the group consisting of: isopropyl alcohol, n-propyl alcohol, n-butyl alcohol, sec-butyl alcohol, isobutyl alcohol, and tert-butyl alcohol.

14. The leather produced by the method of claim 10, claim 11, claim 12, or claim 13.

15. An improved vegetable tanning liquor comprising recycled tannins recovered by alcohol fractionation of spent vegetable tanning liquor.

16. The improved vegetable tanning liquor of claim 15, wherein said recycled tannins are provided in a ratio of 1 part recycled tannins to 4 parts of virgin plant polyphenols.

17. A method of purifying a natural tannin extract comprising:
a. Providing natural tannin extract;
b. adding 4 to 8% bisulfite and cooking the resulting mixture until clear;
c. adding an aqueous fraction recovered from alcohol fractionation of spent vegetable tanning liquor to cause precipitation of insolubles;
d. removing said insolubles;
e. adding an acohol to said mixture and allowing said mixture to settle to form an alcohol fraction and an aqueous fraction;
e. Separating said alcohol fraction from said aqueous fraction; and,
f. Removing said alcohol from said alcohol fraction to form a residue containing aqueous, sulfited, fractionated natural tannin.

18. The method of claim 17, wherein said natural tannin extract is selected from the group consisting of: quebracho tannin extract, wattle tannin extract, and chestnut tannin extract.

19. A residue containing aqueous, sulfited, fractionated quebracho tannin produced by the method of claim 17.

20. A method of recovering plant polyphenols from spent vegetable tanning liquor comprising:
a. providing spent vegetable tanning liquor;
b. adding an alcohol to said spent tanning liquor to form a mixture;
c. agitating said mixture;
d. allowing said mixture to settle to form a precipitate and an aqueous alcohol fraction;
e. separating said precipitate from said aqueous alcohol fraction; and
f. removing said alcohol from said aqueous alcohol fraction to form a residue containing plant polyphenols.

21. The method of claim 20, further comprising the step of adding said residue containing plant polyphenols to virgin tanning liquor to form an improved tanning liquor.

22. The method of claim 20, further comprising the step of recovering and drying said precipitate to produce a soil fertilizer and pH adjustment product.

23. The method of claim 20, wherein said spent tanning liquors provided have solids in the range of 15% to 40% by weight.

24. The method of claim 20, wherein said spent tanning liquors provided have solids in the range of 25% to 30% by weight.

25. The method of claim 20, wherein said alcohol is selected from the group consisting of: ethyl alcohol and methyl alcohol.

26. A residue produced by the method of claim 22, claim 23, claim 24, or claim 25.

27. The soil fertilizer and pH adjustment product produced by the method of claim 21.

28. A method of recovering plant polyphenols from spent vegetable tanning liquor comprising:
a. providing spent vegetable tanning liquor;
b. adding an alcohol to said spent tanning liquor to form a mixture;
c. agitating said mixture;
d. allowing said mixture to settle to form a fraction containing alcohol;
e. isolating said fraction containing alcohol; and,
f. removing said alcohol from fraction to form a residue containing plant polyphenols.
